(19) United States
(12) Patent Application Publication
(10) Pub. No.: US 2025/0007399 A1
(43) Pub. Date: Jan. 2, 2025

(54) METHODS, DEVICES, AND SYSTEMS FOR POWER CONVERTERS

(71) Applicants: The Trustees of Princeton University, Princeton, NJ (US); Murata Manufacturing Co., Ltd., Nagaokakyo-shi (JP)

(72) Inventors: Minjie Chen, Princeton, NJ (US); Yenan Chen, Princeton, NJ (US); Ping Wang, Princeton, NJ (US); David Giuliano, Bedford, NH (US)

(21) Appl. No.: 18/812,964

(22) Filed: Aug. 22, 2024

Related U.S. Application Data
(63) Continuation of application No. PCT/US2023/063149, filed on Feb. 23, 2023.
(60) Provisional application No. 63/313,256, filed on Feb. 23, 2022.
(60) Provisional application No. 63/371,922, filed on Aug. 19, 2022.

(51) Int. Cl. H02M 3/07; H02M 3/158

(52) U.S. Cl. CPC H02M 3/07; H02M 3/158

(57) ABSTRACT

Disclosed embodiments may include High Conversion Ratio Hybrid Switched Capacitor Power Converter, including components for, systems including, and methods for the same. Disclosed embodiments may provide a power conversion circuit and architecture that can achieve high efficiency and high voltage conversion ratio by mixing the operation of a switched capacitor charge distributor and a multiphase DC-DC voltage regulator. The circuits may include a magnetic structure and package that can achieve high performance when providing a high voltage conversion ratio while also offering low output current ripple and a fast dynamic response. The converter can be used, for example, to supply electricity to low voltage high current microprocessors in data centers.

### CROSS-REFERENCE TO RELATED APPLICATIONS

The present application is a continuation of and claims priority to and the benefits of International Patent Application No. PCT/US2023/063149, filed on Feb. 23, 2023, which in turn claims priority to and the benefits of U.S. Patent Application No. 63/313,256, filed on Feb. 23, 2022 and U.S. Patent Application No. 63/371,922, filed on Aug. 19, 2022, the entire contents of all of which are incorporated herein by reference.

### TECHNICAL FIELD

The present disclosure generally relates to power electronic devices. More particularly, the present disclosure relates to DC-DC power converters.

### BACKGROUND

Many electronic products, particularly mobile computing and/or communication products and components (e.g., notebook computers, ultra-book computers, tablet devices, LCD and LED displays), require multiple DC (direct current) voltage levels. For example, radio frequency transmitter power amplifiers may require relatively high voltages (e.g., 12V or more), and logic circuitry may require a low voltage level (e.g., 1-2V). Some other circuitries may require an intermediate voltage level (e.g., 5-10V). Power converters are often used to generate a lower or higher voltage from a common power source, such as a battery, in order to meet the power requirements of different components in the electronic products.

### SUMMARY

Embodiments of the present disclosure provide a power converter. Disclosed embodiments may include a power converter circuit that includes a plurality of charge distributors that include switches, capacitors, and inductors. The plurality of charge distributors may have a fixed voltage conversion ratio. The switches in the plurality of charge distributors may operate at a common frequency. Each of the plurality of charge distributors may include four terminals with one terminal connected to a high voltage, one terminal connected to ground, and two branch terminals having a voltage between the high voltage and ground. The power converter circuit may further include a plurality of voltage regulators that include switches, inductors, and capacitors. The voltage regulators may regulate voltage by changing a duty ratio of the switches. The terminals connected to the high voltage of the charge distributors may be connected to a high voltage terminal of a system, and the low voltage side of the voltage regulators may be connected to a low voltage terminal of the system.

Disclosed embodiments may also involve a coupled inductor that includes a magnetic core having three voids that form four lengths of magnetic core material between two ends. The coupled inductor may also include electrically conductive windings that wrap the four lengths of magnetic core material.

The magnetic core may include a cap layer (alternatively referred to as a cap structure) and/or two layers made of different materials. The cap layer of the magnetic core may include a gap. The windings form a tessellating pattern. The windings may also include posts that extend away from a given face of the magnetic core in a common direction.

Disclosed embodiments may also involve a coupled inductor that includes a magnetic core having twelve voids arranged in a four-by-three grid that form four lengths of magnetic core material between two ends. The coupled inductor may further include electrically conductive windings that wrap the four lengths of magnetic core material, the windings looping through at least one of the twelve voids.

The coupled inductors may have a magnetic core includes a cap layer and/or two layers made of different materials. The cap layer of the magnetic core may include a gap. The windings form a tessellating pattern. The windings may also include posts that extend away from a given face of the magnetic core in a common direction.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

### BRIEF DESCRIPTION OF THE DRAWINGS

Embodiments and various aspects of the present disclosure are illustrated in the following detailed description and the accompanying figures. It is noted that, in accordance with standard practice in the industry, various features are not drawn to scale. In fact, the dimensions of the various features may be arbitrarily increased or reduced for clarity of discussion.

FIG. 1 is a diagram illustrating an exemplary power converter, in accordance with some embodiments of the present disclosure.

FIG. 2 is a diagram illustrating an exemplary power converter, in accordance with some embodiments of the present disclosure.

FIG. 3 is a diagram illustrating an exemplary power converter, in accordance with some embodiments of the present disclosure.

FIG. 4A is a graph illustrating an example operation of an exemplary power converter, in accordance with some embodiments of the present disclosure.

FIG. 4B is a diagram illustrating an exemplary power converter, in accordance with some embodiments of the present disclosure.

FIG. 4C is a diagram illustrating an exemplary power converter, in accordance with some embodiments of the present disclosure.

FIGS. 5A and 5B are diagrams illustrating exemplary power converter, in accordance with some embodiments of the present disclosure.

FIGS. 5C and 5D are diagrams illustrating example operations of the exemplary power converter shown in FIG. 5B, in accordance with some embodiments of the present disclosure.

FIG. 6A is a diagram illustrating an exemplary power converter, in accordance with some embodiments of the present disclosure.

FIGS. 6B, 6C, and 6D are diagrams illustrating exemplary power regulator, in accordance with some embodiments of the present disclosure.

FIGS. 7A and 7B are diagrams illustrating exemplary power converter, in accordance with some embodiments of the present disclosure.

FIGS. 8A and 8B are diagrams illustrating exemplary power converter, in accordance with some embodiments of the present disclosure.

FIGS. 9A and 9B are diagrams illustrating exemplary power converter employing coupled inductors, in accordance with some embodiments of the present disclosure.

FIG. 10 is a diagram illustrating an exemplary power converter, in accordance with some embodiments of the present disclosure.

FIG. 11 is a diagram illustrating an exemplary power converter employing coupled inductors, in accordance with some embodiments of the present disclosure.

FIG. 12 is a diagram illustrating an exemplary power converter employing coupled inductors and MOSFET switches, in accordance with some embodiments of the present disclosure.

FIG. 13 is a diagram illustrating an exemplary power converter employing coupled inductors and MOSFET switches, in accordance with some embodiments of the present disclosure.

FIGS. 14 and 15 are graphs illustrating an example operation of the exemplary power converter depicted in FIG. 12, in accordance with some embodiments of the present disclosure.

FIG. 16 is a diagram illustrating an exemplary power converter, in accordance with some embodiments of the present disclosure.

FIG. 17 is a diagram illustrating an exemplary power converter, in accordance with some embodiments of the present disclosure.

FIGS. 18A and 18B are diagrams illustrating low dropout implementations for controlling switches, in accordance with some embodiments of the present disclosure.

FIG. 19 is a diagram illustrating exemplary coupled inductors, in accordance with some embodiments of the present disclosure.

FIGS. 20A, 20B, and 20C illustrate an exemplary coupled inductor, in accordance with some embodiments of the present disclosure.

FIGS. 21A, 21B, and 21C illustrate an exemplary coupled inductor, in accordance with some embodiments of the present disclosure.

FIG. 22 illustrates an exemplary coupled inductor with mixed core materials, in accordance with some embodiments of the present disclosure.

FIG. 23 illustrates a plot of simulated performance of exemplary coupled inductors, in accordance with some embodiments of the present disclosure.

FIG. 24 illustrates an exemplary coupled inductor, in accordance with some embodiments of the present disclosure.

FIGS. 25 and 26 illustrate example systems that include an exemplary coupled inductor, in accordance with some embodiments of the present disclosure.

FIGS. 27A, 27B, and 27C illustrate an exemplary coupled inductor, in accordance with some embodiments of the present disclosure.

FIG. 28 illustrates an exemplary coupled inductor, in accordance with some embodiments of the present disclosure.

FIG. 29 illustrates an example power converter for receiving a coupled inductor, in accordance with some embodiments of the present disclosure.

FIG. 30 illustrates an exemplary coupled inductor, in accordance with some embodiments of the present disclosure.

FIG. 31 illustrates a schematic of an exemplary voltage regulator module (VRM) embedded in package with a microprocessor, in accordance with some embodiments of the present disclosure.

FIG. 32 illustrates a schematic of an exemplary architecture for a microprocessor VRM, in accordance with some embodiments of the present disclosure.

FIG. 33 illustrates a schematic of the topology of an exemplary architecture for a microprocessor VRM, in accordance with some embodiments of the present disclosure.

FIG. 34 illustrates exemplary operation waveforms for a microprocessor VRM based on multistack switched-capacitor point-of-load (MSC-PoL) architecture, in accordance with some embodiments of the present disclosure.

FIGS. 35A, 35B, and 35C illustrate schematics of an exemplary coupled inductor with a ladder core, windings, and magnetic plate, respectively, in accordance with some embodiments of the present disclosure.

FIG. 36 illustrates schematic of an exemplary coupled inductor including an air gap, in accordance with some embodiments of the present disclosure.

FIGS. 37A and 37B illustrate schematics of a top view and a bottom assembly view, respectively, of an exemplary MSC-POL architecture for a microprocessor VRM, in accordance with some embodiments of the present disclosure.

FIGS. 38A, 38B, and 38C illustrate schematics of exemplary circuit designs for switches in MSC-POL architecture for a microprocessor VRM, in accordance with some embodiments of the present disclosure.

FIGS. 39A and 39B illustrate schematics of top view and a side view, respectively, of hardware layout of an exemplary VRM, in accordance with some embodiments of the present disclosure.

FIG. 40 illustrates a plot of measured inductor current and switched node voltages of an exemplary coupled inductor, in accordance with some embodiments of the present disclosure.

FIG. 41 illustrates a plot comparing the conversion efficiency of exemplary coupled inductors, in accordance with some embodiments of the present disclosure.

FIG. 42 illustrates a hot-spot temperature profile of an exemplary coupled inductor, in accordance with some embodiments of the present disclosure.

FIG. 43 illustrates a schematic of an exemplary coupled inductor, in accordance with some embodiments of the present disclosure.

FIG. 44 illustrates a schematic of an exemplary coupled inductor, in accordance with some embodiments of the present disclosure.

FIGS. 45A and 45B illustrate schematics of an exemplary coupled inductor, in accordance with some embodiments of the present disclosure.

FIGS. 46A and 46B illustrate schematics of an exemplary coupled inductor, in accordance with some embodiments of the present disclosure.

FIG. 47 illustrates a schematic of an exemplary coupled inductor, in accordance with some embodiments of the present disclosure.

FIG. 48 illustrates an exemplary inductor and efficiency graph, in accordance with some embodiments of the present disclosure.

FIG. 49 illustrates an exemplary leakage inductance graph and an exemplary current ripple graph, in accordance with some embodiments of the present disclosure.

FIG. 50 illustrates exemplary inductors and the flux saturation at heavy loads of an inductor, in accordance with some embodiments of the present disclosure.

FIG. 51 illustrates an exemplary graph of the impact of the thickness of an air gap of an inductor on efficiency, in accordance with some embodiments of the present disclosure.

FIG. 52 illustrates exemplary graphs of the impact of switching capacity on efficiency, in accordance with some embodiments of the present disclosure.

FIG. 53 illustrates exemplary views of an inductor with one or more magnetic sheets and an exemplary graph showing the effect of the number of magnetic sheets on efficiency, in accordance with some embodiments of the present disclosure.

FIG. 54 illustrates exemplary graphs and a table, in accordance with some embodiments of the present disclosure.

FIG. 55 illustrates exemplary graphs and an inductor core, in accordance with some embodiments of the present disclosure.

FIG. 56 illustrates a schematic of an exemplary inductor, in accordance with some embodiments of the present disclosure.

FIG. 57 illustrates a schematic of an exemplary inductor, in accordance with some embodiments of the present disclosure.

FIG. 58 illustrates an exemplary circuit diagram of an inductor and a graph, in accordance with some embodiments of the present disclosure.

FIG. 59 illustrates an exemplary circuit diagram of an inductor and a graph, in accordance with some embodiments of the present disclosure.

FIG. 60 illustrates an exemplary circuit diagram of an inductor and graphs, in accordance with some embodiments of the present disclosure.

FIG. 61 illustrates exemplary graphs, in accordance with some embodiments of the present disclosure.

FIG. 62 illustrates exemplary graphs with measured waveforms, in accordance with some embodiments of the present disclosure.

### DETAILED DESCRIPTION

The following disclosure provides many different exemplary embodiments, or examples, for implementing different features of the provided subject matter. Specific simplified examples of components and arrangements are described below to explain the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Throughout the figures, components may be referenced using a combination of alphanumeric characters, some of which may include subscripts. Within this specification, the subscripts may be formatted as plain characters. For example, “V_{HIGH}” from the figures may be referred to as “VHIGH” within the specification. As another example, “Q₁” from the figures may be referred to as “Q1” within the specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this document, the term “coupled” may also be termed as “electrically coupled,” and the term “connected” may be termed as “electrically connected.” “Coupled” and “connected” may also be used to indicate that two or more elements cooperate or interact with each other.

Throughout this disclosure, embodiments are discussed in relation to particular electrical components, such as capacitors and inductors. Although an individual component may be discussed (e.g., a single capacitor, a single inductor), a combination of multiple components may be substituted for the single component. For example, while a single capacitor may be discussed or depicted, two or more capacitors (e.g., in series, parallel, or a combination of the two) may be substituted so long as the required qualities remain the same. In this example, an embodiment that calls for a single 20 mF capacitor may use two capacitors of 10 mF in parallel instead. Similar substitutions may be made for inductors.

Various embodiments of the present disclosure will be described with respect to embodiments in a specific context, such as a switched capacitor power converter. As used in this disclosure, the term “switched capacitor converter” may refer to a switched-capacitor network configured to convert an input voltage to an output voltage. The network may use switches to change between two or more circuit configurations to alter the voltage between the input and output terminals. Although not discussed in detail herein, disclosed embodiments may rely on level shifters and gate drivers to control the switches between open and closed states. Disclosed embodiments may operate using varying switching frequencies, such as 50 kHz to 500 MHZ.

Disclosed embodiments may include circuits and techniques to power converters and more particularly to power converters having a high voltage conversion ratio, requiring small output current ripple, and demanding fast-dynamic response. Disclosed embodiments may include a converter that is particularly suitable to power microprocessors in data centers, telecom base stations, and consumer electronics.

Disclosed embodiments may include a power conversion circuit and architecture that can achieve high efficiency and high voltage conversion ratio by mixing the operation of a switched capacitor charge distributor and a multiphase DC-DC voltage regulator. The circuits may include a magnetic structure and package, which may achieve high performance with a high voltage conversion ratio while offering low output current ripple and fast dynamic response. The converter can be used, for example, to supply electricity to low voltage high current microprocessors in data centers.

General-purpose and energy efficient computing may benefit from DC-DC converters with very low output voltage (<2V), high output current (>50 A) and high voltage conversion ratio (>10:1). Power converters that can provide a low voltage output (<2 V) regulated at wide bandwidth, while drawing energy from a higher, wide-ranging input voltage (e.g., typically between 40V to 60V) may be useful for supporting high performance microprocessors and telecommunications processing loads. The size, cost, and performance advantages of integration may be desirable for designing modular and miniaturized DC-DC converters that can be easily scaled in size for a variety of applications with different voltage and current need.

Switched-mode power converter may be used to step-down voltage. These types of converters may transfer energy from the converter input to output with the help of inductors or coupled inductors. Such magnetic-based topologies may include synchronous buck converters, interleaved synchronous buck converters, three-level buck converters, and many others. Designs of this type may efficiently provide a regulated output from a variable input voltage with high-bandwidth control of the output. However, such designs may not be suitable for applications with high input voltage. For example, switches in a buck converter need to handle both high input voltage stress and high output current stress. To achieve high conversion ratio, the duty cycle of a buck converter needs to be low. Narrow duty cycle and high inductor blocking voltage lead to higher core loss and larger inductor size. For voltage regulators, it is beneficial to increase the operation frequency to reduce passive component size and increase control bandwidth. However, the hard-switching operation may limit the switching frequency as well as the efficiency and power density that can be achieved. They also may include packaging constraints.

A two-stage intermediate bus architecture (IBA) may offer high voltage conversion ratios and high output currents. In a two-stage IBA design, the front-end stage may be implemented as a 48V to 12V transformer-based isolated DC-DC converter without regulation or switched-capacitor circuits. The second stage may be implemented as a multi-phase buck converter. The switches of the front-end stage and the second stage may not necessarily need to handle both high voltage stress and high current stress. However, isolation in the front-end stage of IBA may not be needed, and transformer-based designs may suffer from low control bandwidth due to inherent resonant characteristics. Also, the transformers in these architectures may need to handle high flux while carry high current, which may place challenges on efficiency, power density, and dynamic performance.

Another approach for the front-end stage of IBA may include a switched capacitor (SC) based DC-DC converter. This family of converters may be suited for high density designs. A SC circuit may include of a network of switches and capacitors, where the switches can be turned on and off periodically to cycle the network through different operational states. Switched capacitor DC-DC converters, however, may be limited in that they may provide relatively poor output voltage regulation in the presence of varying input voltage or load. As the conversion ratio differs from the optimal ratio, the efficiency of the switched capacitor converter may decrease.

A second stage for voltage regulation may be used in an IBA since both transformer-based DC-DC converters and SC based DC-DC converters are unregulated. The second stage may be implemented as a multi-phase buck converter regulating the output voltage from the intermediate bus. Decreasing the intermediate bus voltage can reduce the switching loss, enable higher switching frequency and improve the dynamic response of multi-phase buck converter. However, having a lower intermediate bus voltage may necessitate the front-end stage providing a higher voltage conversion ratio. Because SC-based DC-DC converters may have poor voltage regulation capabilities, multiple SC converters with fixed a step-down ratio may be cascaded in the front-end stage to fulfill a higher voltage conversion ratio. These approaches may not satisfactorily achieve desired levels of efficiency and power density for both front-end stage and second voltage regulator in the intermediate bus architecture. Disclosed embodiments may address these challenges to achieve high efficiency and fast dynamic response of the SC-based power converters while maintaining the high-bandwidth output regulation and high overall efficiency for point-of-load applications.

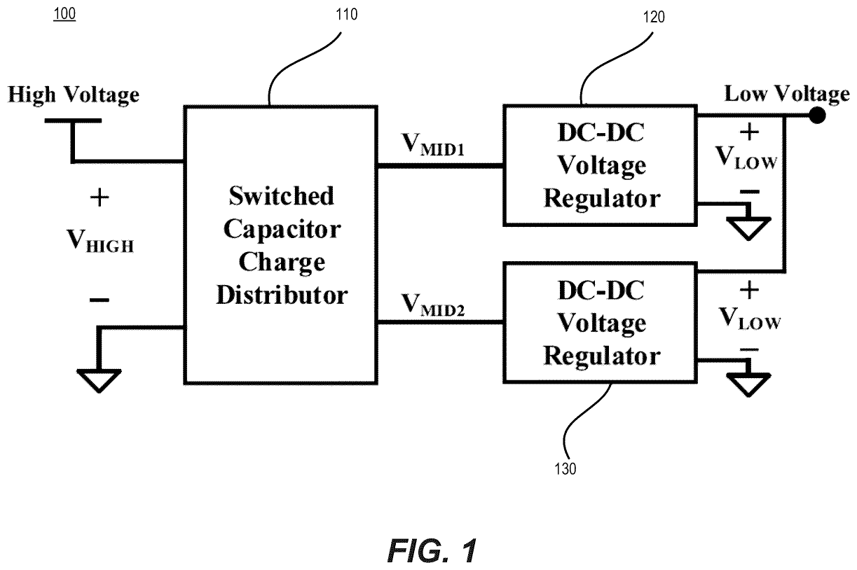

FIG. 1 is a diagram illustrating an exemplary power converter 100, in accordance with some embodiments of the present disclosure. Power converter 100 may provide an architecture for high step voltage conversion with high efficiency and compact size. As shown, power converter 100 may include switched capacitor charge distributor 110, DC-DC voltage regulator 120, and DC-DC voltage regulator 130. Charge distributor 110 may be connected in series with voltage regulator 120 and voltage regulator 130. Voltage regulator 120 may be in parallel with voltage regulator 130.

In some embodiments, converter 100 may transfer energy from the high voltage (HV) terminal to the low voltage (LV) terminal. The charge distributor 110 may convert the input voltage at the HV terminal to two intermediate bus voltages VMID1 and VMID2 that are smaller than the input voltage. The voltage regulators 120 and 130 may receive the intermediate bus voltages VMID1 and VMID2 respectively and provide a regulated output voltage at the LV terminal with their output terminals connected in parallel. In some embodiments, converter 100 may alternatively or additionally transfer energy from the LV terminal to the HV terminal. For example, the voltage regulators 120 and 130 may accept the input voltage at the LV terminal and provide two intermediate bus voltages VMID1 and VMID2 that are higher than the input voltage. The switched capacitor charge distributor 110 may convert the intermediate bus voltages to an output voltage at the HV terminal which is higher than the intermediate bus voltages. This type of converter may be suitable to supply low voltage (e.g., 0.5 V-to-1.8 V) from higher voltage levels with wide variation (e.g., 40 V to 60 V). This type of converter may also be used to power digital circuits with dynamic voltage scaling, or for supplying power to low power internet-of-things devices, where wide output voltage ranges are needed

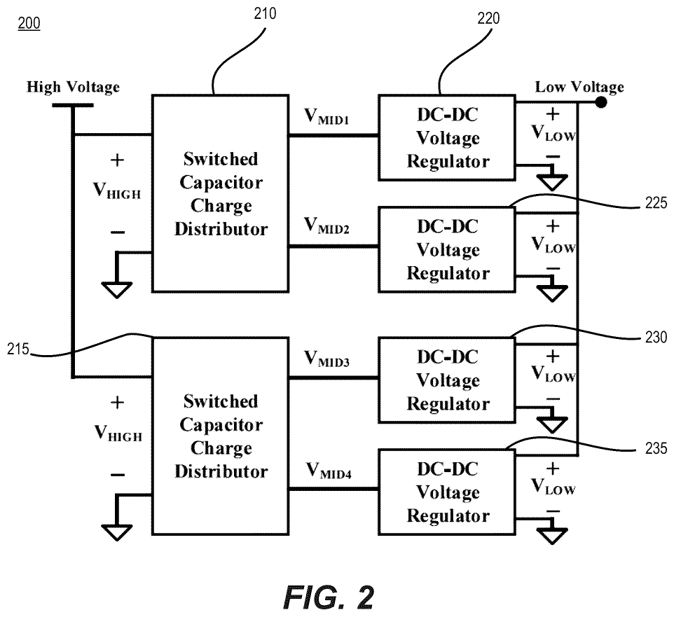

FIG. 2 is a diagram illustrating an exemplary power converter 200, in accordance with some embodiments of the present disclosure. Converter 200 may include two switched capacitor charge distributors 210 and 215 and four DC-DC voltage regulators 220, 225, 230, and 235. As shown, converter 200 may be an example structure of two basic converter units connected in parallel for high output current. For example, converter 200 may be an example of paralleling two of power converters 100 from FIG. 1. This arrangement may support higher output current.

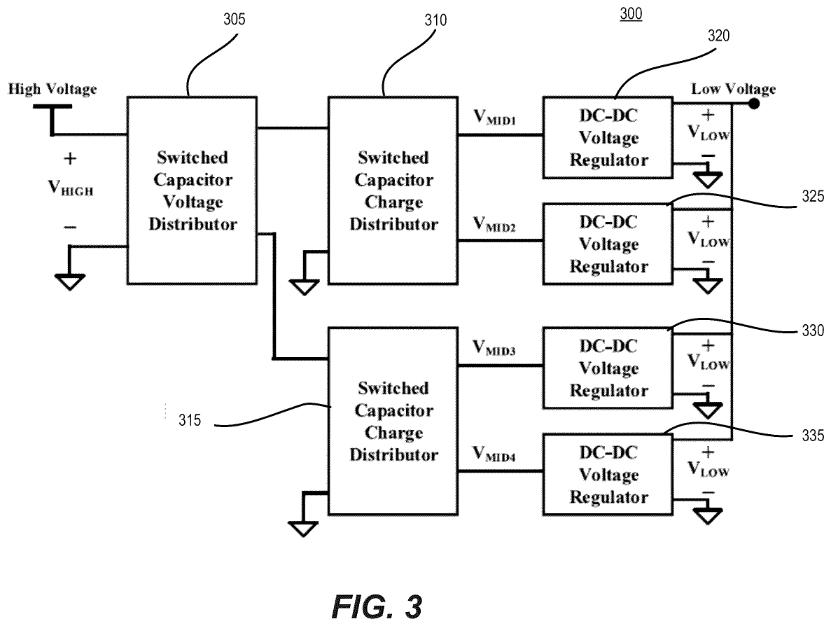

FIG. 3 is a diagram illustrating an exemplary power converter 300, in accordance with some embodiments of the present disclosure. Converter 300 may include three switched capacitor charge distributors 305, 310, and 315 and four DC-DC voltage regulators 320, 325, 330, and 335. As shown, converter 300 may be an extension of converter 200 of FIG. 2. For example, converter 300 may include the same two distributors and four voltage regulators of converter 200, but converter 300 may add a third switched capacitor charge distributor (e.g., distributor 305) to drive the two switched capacitor charge distributors 310 and 315, creating four intermediate bus voltages VMID1 to VMID4 for four dc-dc voltage regulators. This extended architecture can support higher voltage levels (e.g., 80 V to 120 V). It can be further extended by cascading switched capacitor charge distributors. For example, there may be one charge distributor at the first level and two charge distributors at the second level. Although not shown, this pattern may continue on subsequent levels, e.g., with 2ⁿ charge distributors at the (n+1)^{th} level, which may be used to create 2ⁿ intermediate bus voltages

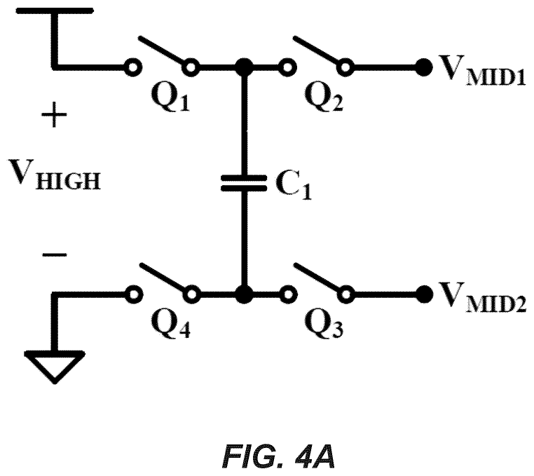

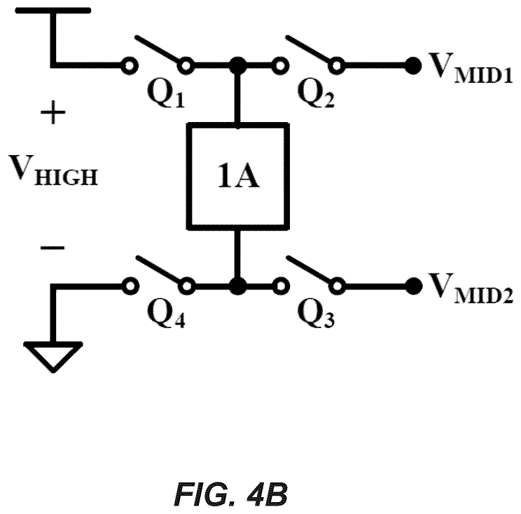

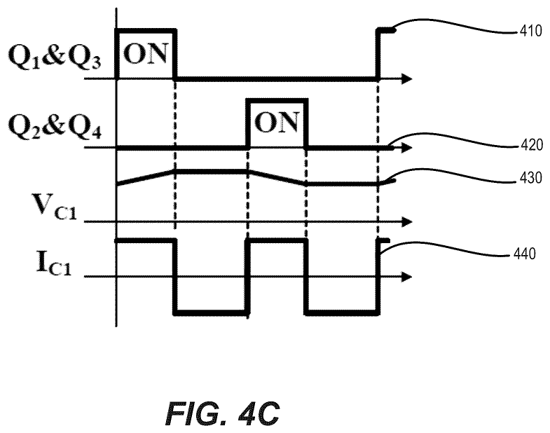

FIG. 4A is a graph illustrating an example operation of an exemplary power converter 400A, in accordance with some embodiments of the present disclosure. Converter 400A may include input voltage VHIGH, switches Q1, Q2, Q3, and Q4, capacitor C1, and output nodes VMID1 and VMID2. As shown, converter 400A may form a switched capacitor charge distributor with a 2:1 voltage conversion ratio. For example, VHIGH may be reduced by half by selectively switching switches Q1, Q2, Q3, and Q4.

FIG. 4B is a diagram illustrating an exemplary power converter 400B, in accordance with some embodiments of the present disclosure. Similar to converter 400A, converter 400B may include input voltage VHIGH, switches Q1, Q2, Q3, and Q4, and output nodes VMID1 and VMID2. Instead of depicting a capacitor, however, converter 400B may include charge storage block 1A. In some embodiments, charge storage block 1A may be a device that stores capacitors. For example, charge storage block 1A may include one or more capacitors. In other examples, charge storage block 1A may further include one or more inductors. The inductors may be placed in parallel or series with one or more capacitors, which may permit converter 400B to be multi-resonant.

In some embodiments, pairs of switches Q1, Q2, Q3, and Q4 in converter 400A (of FIG. 4A) and 400B (of FIG. 4B) may be commonly controlled. FIG. 4C is a diagram illustrating an exemplary power converter circuit operational plot 400C, in accordance with some embodiments of the present disclosure. Plot 400C depicts graph 410 showing the state of the control signal for switches Q1 and Q3 over time. Graph 420 shows the state of the control signal for switches Q2 and Q4 over time. Graphs 430 and 440 show the resulting voltage VC1 and current IC1, respectively, over time across capacitor C1 of converter 400A (or, even though labeled with subscript “C1,” the voltage and current across charge storage block 1A of converter 400B).

Graphs 410, 420, 430 and 440 depict an example operation for converters 400A and 400B. For example, when are Q1 and Q3 turned on, one output terminal voltage VMID2 may be equal to VHIGH-VC1. When are Q2 and Q4 turned on, the other output terminal voltage VMID1 may be equal to VC1. The on-time of Q1 and Q3 may be the same the on-time of Q2 and Q4, and the combined on-time for each may be less than half of the entire switching period. The intermediate bus voltages VMID1 and VMID2 are approximately equal. The voltage across the HV terminal and the intermediate bus voltages VMID1 and VMID2 are approximately 2:1.

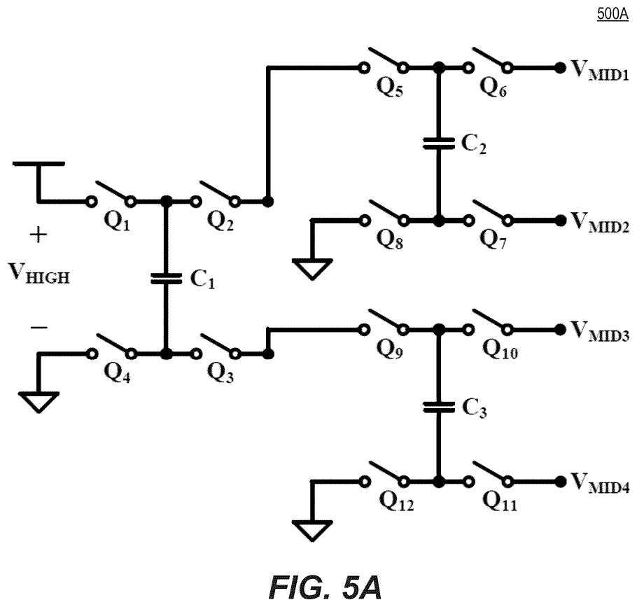

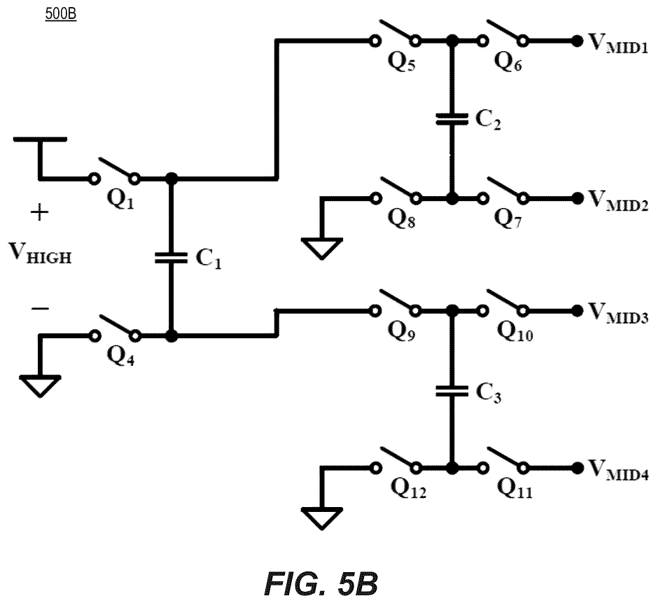

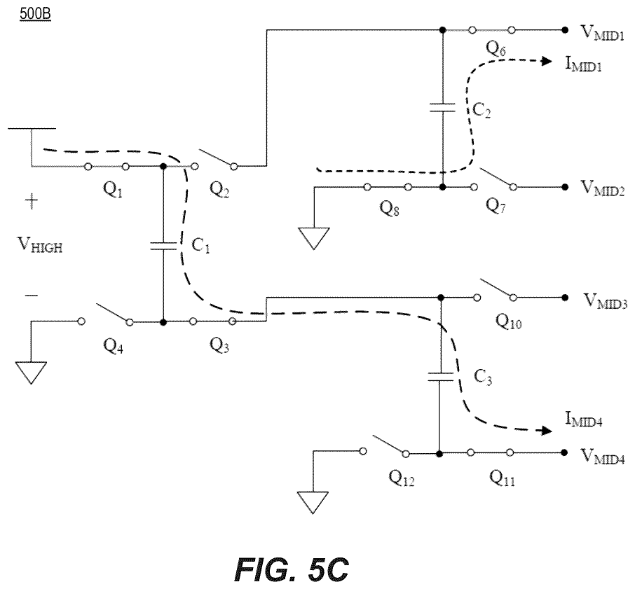

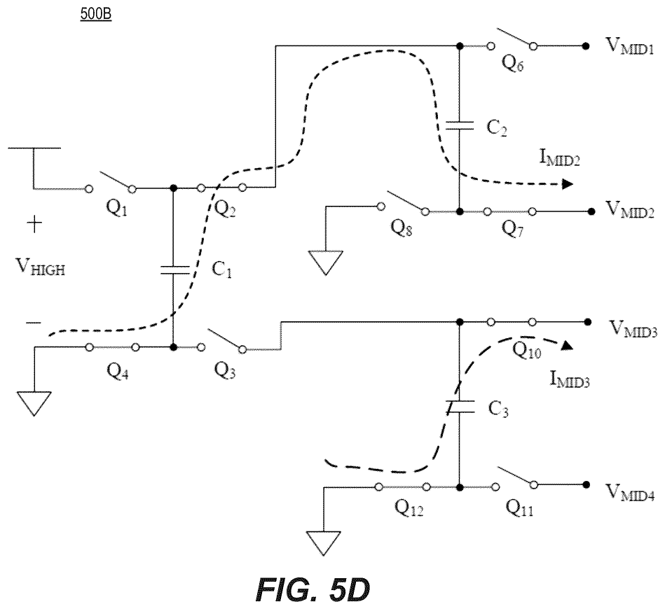

FIG. 5A is a diagram illustrating an exemplary power converter 500A, in accordance with some embodiments of the present disclosure. As shown converter 500A may include twelve switches Q1, Q2, Q3, Q4, Q5, Q6, Q7, Q8, Q9, Q10, Q11, and Q12, and three capacitors C1, C2, and C3. Converter 500A may receive voltage VHIGH and provide output nodes VMID1, VMID2, VMID3, and VMID4. Effectively, these components may implement three instances of converter 400A. Converter 500A may form a switched capacitor charge distributor with extended voltage conversion ratio. Two 2:1 charge distributors may be directly connected to the two output terminals of the front-end 2:1 charge distributor and the overall voltage conversion ratio is 4:1.

In some embodiments, converter 500A may include reduced numbers of switches while providing similar operation. FIG. 5B is a diagram illustrating an exemplary power converter circuit 500B, in accordance with some embodiments of the present disclosure. Considering several switches in converter 500A of FIG. 5A are connected in series and their control signals may be the same, converter 500A in FIG. 5A can be simplified to be converter 500B in FIG. B. For example, converter 500B may replace two series-connected switches by one switch, e.g., each pair of Q2 and Q5, and Q3 and Q9 in converter 500A of FIG. 5A may be replaced with a single switch in converter 500B of FIG. 5B (e.g., switches Q5 and Q9, respectively). In some embodiments, the replaced switches in converter 500B may need to have a higher voltage rating than if pairs of switches were used.

Converters 500A and 500B may maintain the charge balance of the capacitors in the switched capacitor charge distributors by using active control with capacitor voltage feedback. The switched capacitor charge distributor architecture (e.g., converters 500A and 500B) may include automatic charge balancing if the following DC-DC voltage regulators share the same current.

FIGS. 5C and 5D are diagrams illustrating example operations and configurations of the exemplary power converter 500B shown in FIG. 5B, in accordance with some embodiments of the present disclosure. In the configuration shown in FIG. 5C, converter 500B has switches Q1, Q3, Q6, Q8, and Q11 in an closed (e.g., electrically conductive) position, and switches Q2, Q4, Q7, Q10, and Q12 are in an open (e.g., no electrical path) position. As shown in FIGS. 5C and 5D, C1 may be charged by IMID4 and discharged by IMID2. C2 may be charged by IMID2 and discharged by IMID1. C3 may be charged by IMID4 and discharged by IMID3. If the total charge extracted through the four ports VMID1, VMID2, VMID3, VMID4 are approximately equal, converter 500B may be able to ensure that each capacitor is charge balanced.

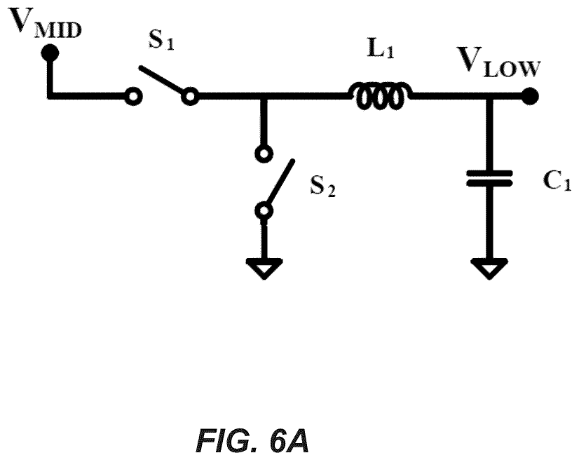

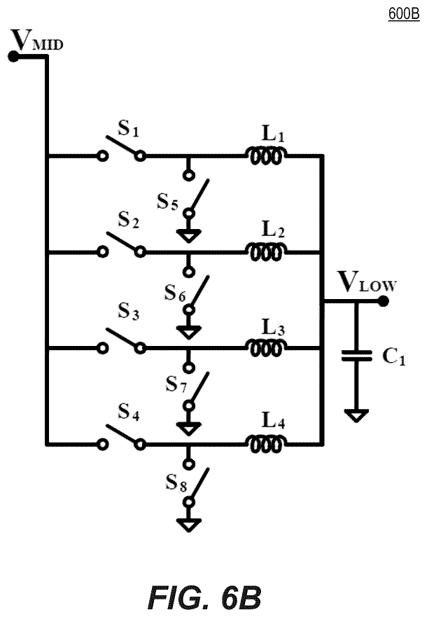

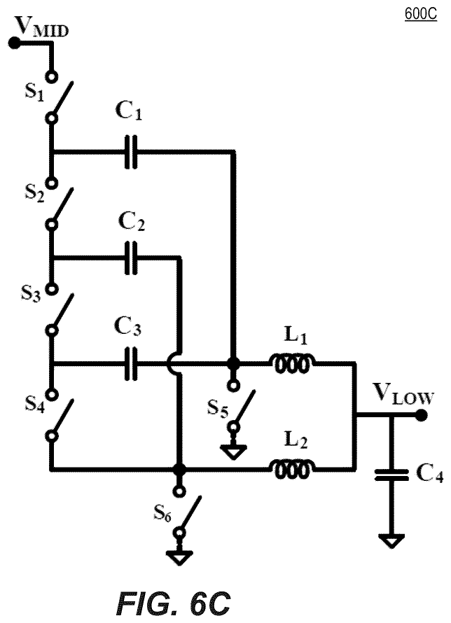

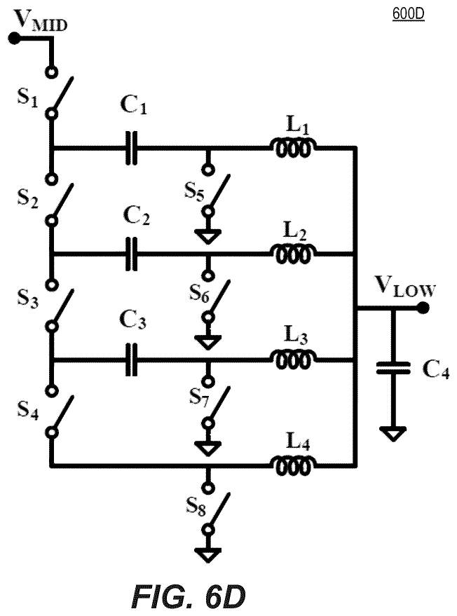

FIG. 6A is a diagram illustrating an exemplary power converter 600A, in accordance with some embodiments of the present disclosure. As shown, power converter 600A may include switches S1 and S2, inductor L1, and capacitor C1, with nodes VMID and VLOW. A middle voltage node VMID may provide input voltage, with switch S1 and inductor L1 between node VMID and node VLOW. Converter 600A may be understood to be a single phase buck converter. For example, converter 600A may step down the voltage, such as at a 2:1 ratio.

FIG. 6B is a diagram illustrating an exemplary power regulator 600B, in accordance with some embodiments of the present disclosure. As shown, power regulator 600B may include switches S1 through S8, inductors L1 through L4, and capacitor C1, with nodes VMID and VLOW. Regulator 600B may be a multiphase buck voltage regulator.

FIG. 6C is a diagram illustrating an exemplary power regulator 600C, in accordance with some embodiments of the present disclosure. As shown, power regulator 600C may include switches S1 through S6, inductors L1 and L2, and capacitors C1 through C4, with nodes VMID and VLOW. Regulator 600C may be a hybrid-switched-capacitor multi-inductor buck voltage regulator.

FIG. 6D is a diagram illustrating an exemplary power regulator 600D, in accordance with some embodiments of the present disclosure. As shown, power regulator 600C may include switches S1 through S8, inductors L1 through L4, and capacitors C1 through C4, with nodes VMID and VLOW. Regulator 600D may be a multiphase (e.g., four-phase) series-capacitor buck voltage regulator.

In some embodiments, regulator 600D may receive an intermediate bus voltage (VMID) and split the intermediate bus voltage with multiple series-stacked high side switches (S1 through S4). One terminal of each of the series capacitors (C1, C2, and C3) may be connected to the source of the high side switch and the other terminal of the series capacitors may be connected to the drain of the low side switch in the same phase. The high side switch and low side switches may be controlled by a pair of complementary gate driver signals. The inductors of the series-capacitor buck converter may or may not be coupled. Compared to a conventional multiphase buck converter, the multiphase series-capacitor buck converter 600D may have lower device voltage stress. For example, the switches of multiphase buck regulator 600B in FIG. 6B may need to block the entire intermediate bus voltage VMID. By comparison, the voltage stress within regulator 600D is VIB/4 for switches S1 and S5-S8, and VMID/2 for S2-S4 in a four-phase series-capacitor buck regulator 600D of FIG. 6D.

In some embodiments, converter 600A, regulator 600B, regulator 600C, and regulator 600D may serve as examples of DC-DC voltage regulators as used in disclosed embodiments. For example, regulators 120 and 130 of converter 100 may be any of converter 600A, regulator 600B, regulator 600C, and regulator 600D. The same may apply to DC-DC voltage regulators 220, 225, 230, and 235 of converter 200, as well as regulators 320, 325, 330, and 335 of converter 300.

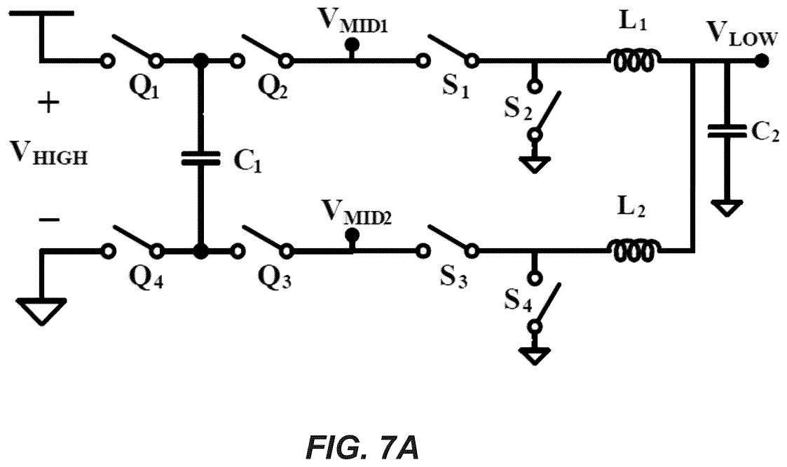

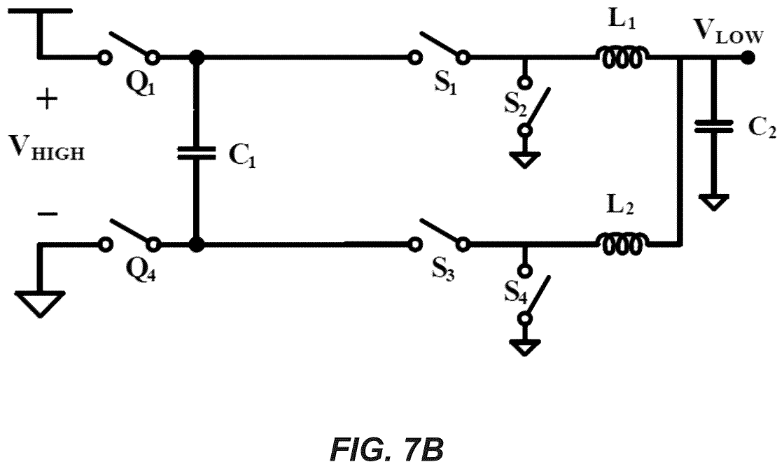

FIGS. 7A and 7B are diagrams illustrating exemplary power converters 700A and 700B, respectively, in accordance with some embodiments of the present disclosure. Power converter 700A may include switches Q1 through Q4, switches S1 through S4, capacitors C1 and C2, and inductors L1 and L2. Power converter 700A may also include nodes VHIGH (positive and negative), VMID1, VMID2, and VLOW. Power converter 700A may include one embodiment of the basic unit of the high conversion ratio architecture, a 2:1 switched capacitor charge distributor that drives two single-phase buck converters.

In some embodiments, power converter 700B may include switches Q₁ and Q4, switches S1 through S4, capacitors C1 and C2, and inductors L1 and L2. Power converter 700B may represent a simplified version of the circuit shown for power converter 700A. For example, in converter 700A, switches Q2 and S1 are connected in series, and switches Q3 and S3 are connected in series. Each of these pairs of switches may be combined and reduced to be a single switch, which forms the circuit shown for converter 700B.

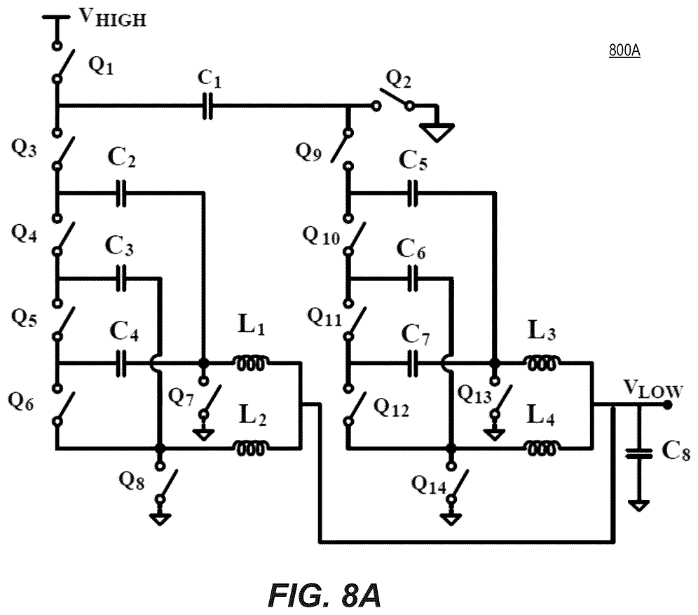

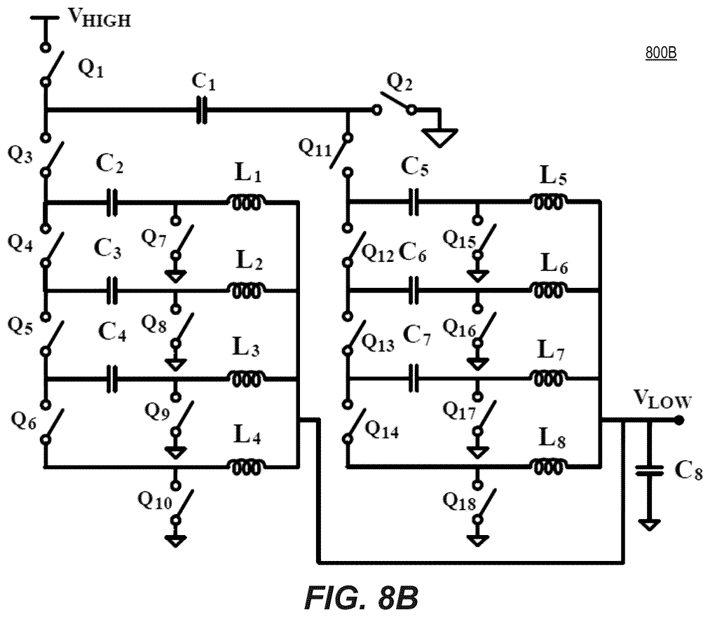

FIGS. 8A and 8B are diagrams illustrating exemplary power converters 800A and 800B, respectively, in accordance with some embodiments of the present disclosure. Power converter 800A may include nodes VHIGH and VLOW, switches Q₁ through Q14, capacitors C1 through C8, and inductors L1 through L4. As shown, converter 800A may form a 2:1 switched capacitor charge distributor that drives two hybrid-switched-capacitor multi-inductor buck converter (e.g., two of regulator 600C of FIG. 6C). Power converter 800B may include nodes VHIGH and VLOW, switches Q1 through Q18, capacitors C1 through C8, and inductors L1 through L8. As shown, converter 800A may form a 2:1 switched capacitor charge distributor that drives two four-phase series-capacitor buck converters (e.g., two of regulator 600D from FIG. 6D). Converters 800A and 800B may be suitable for 48 V to 1 V conversion ratio.

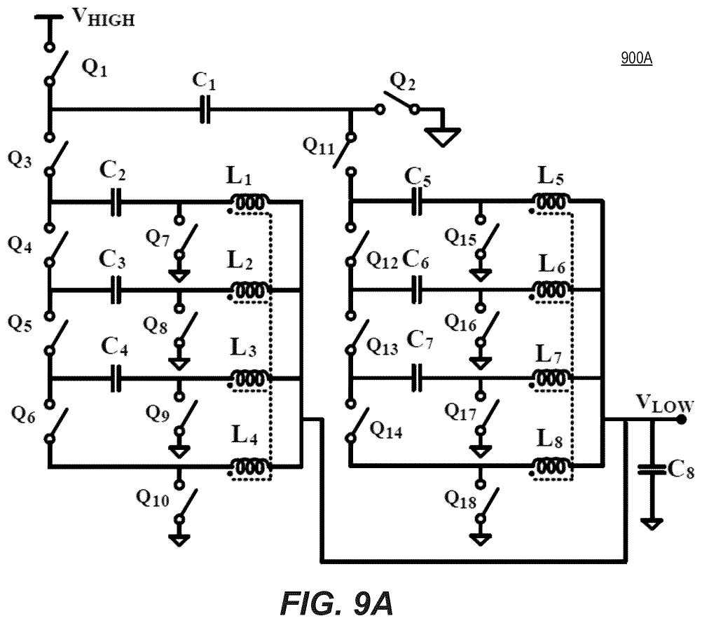

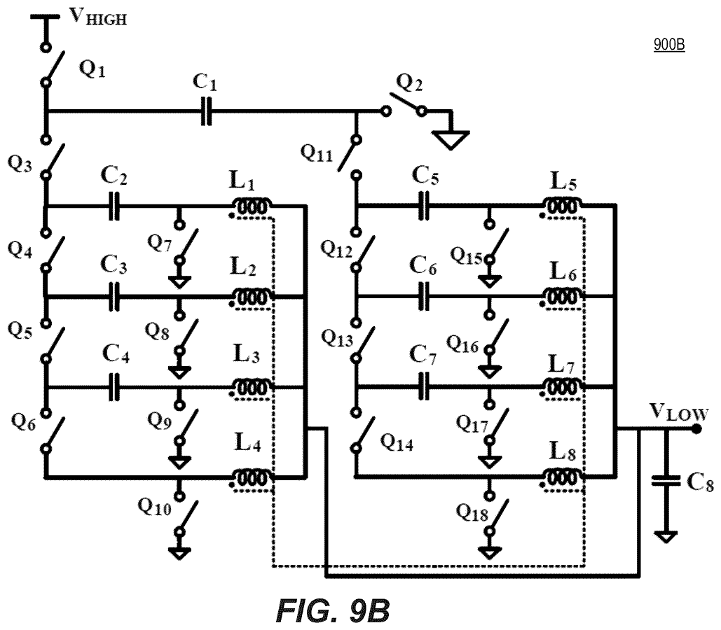

FIGS. 9A and 9B are diagrams illustrating exemplary power converters 900A and 900B, respectively, employing coupled inductors, in accordance with some embodiments of the present disclosure. Converters 900A and 900B may generally include the same components as arranged in converter 800B of FIG. 8B. The inductors of converter 900A and converter 900B may be coupled. In converter 900A, the coupled inductor may couple all the buck phases in the same unit with one magnetic core. For example, inductors L1 through L4 may be coupled together, and inductors L5 through L8 may be coupled together. In this example, the total number of magnetic cores may equal the number of series-capacitor buck units. In converter 900B, the coupled inductor may couple all 8 buck phases with only one magnetic core. For example, inductors L1 through L8 may all be coupled together, as shown in FIG. 9B. Here, the coupling may be between inductors of multiple buck converters, which may further increase the power density in comparison to having used uncoupled inductors.

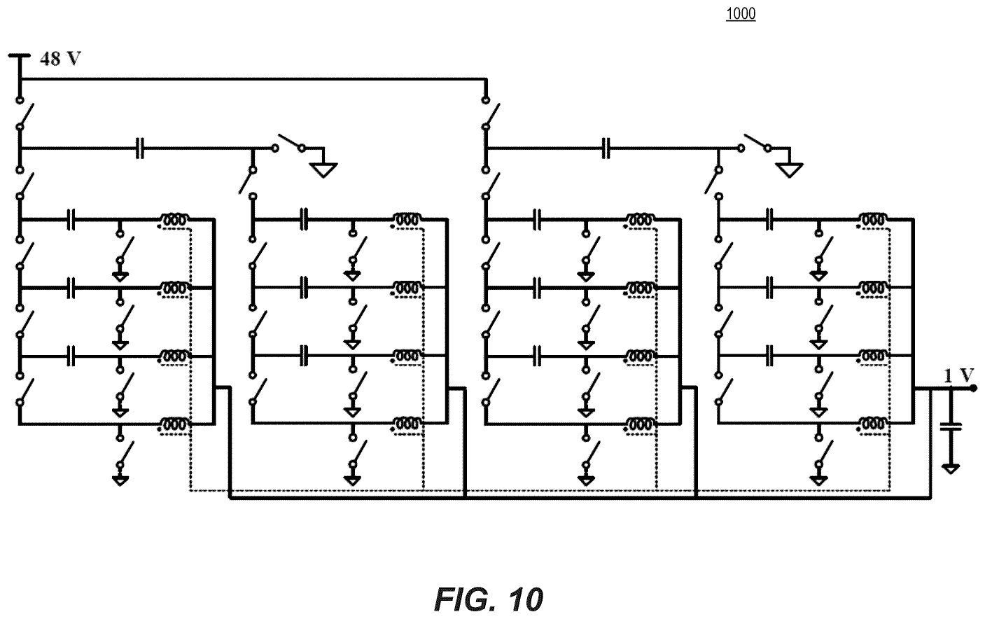

FIG. 10 is a diagram illustrating an exemplary power converter 1000, in accordance with some embodiments of the present disclosure. Converter 1000 may include an example topology of a 48 V to 1 V converter with two basic units connected in parallel for higher output current. As shown, all 16 inductors of converter 1000 are coupled together. In this way, converter 1000 may include a coupled inductor that couples all 16 series-capacitor buck phases.

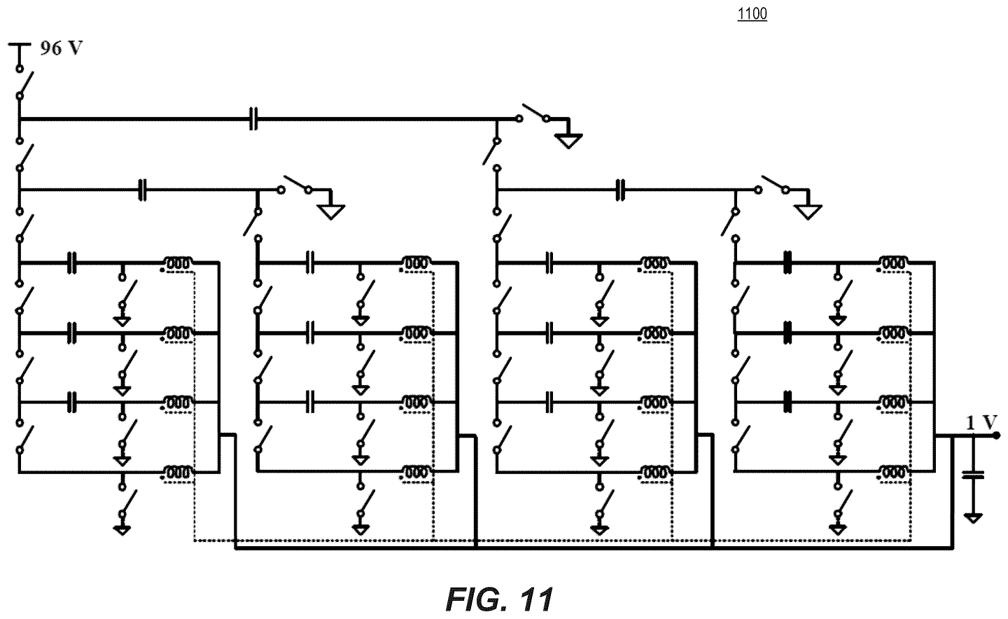

FIG. 11 is a diagram illustrating an exemplary power converter 1100 employing coupled inductors, in accordance with some embodiments of the present disclosure. Converter 1000 provides example topology of the 96 V-1 V converter. Converter 100 may include a front-end 2:1 switched capacitor charge distributor, two 2:1 switched capacitor charge distributors, and four series-capacitor buck voltage regulators. The front-end 2:1 switched capacitor charge distributor may drive two 2:1 switched capacitor charge distributors. Each one of the two 2:1 switched capacitor charge distributors may drive two of the four series-capacitor buck voltage regulators. The architecture of converter 1100 may offer the advantage of providing a voltage reduction capability of 96:1 that is twice the voltage reduction capability of converter 1000 (48:1), while only adding two additional switches.

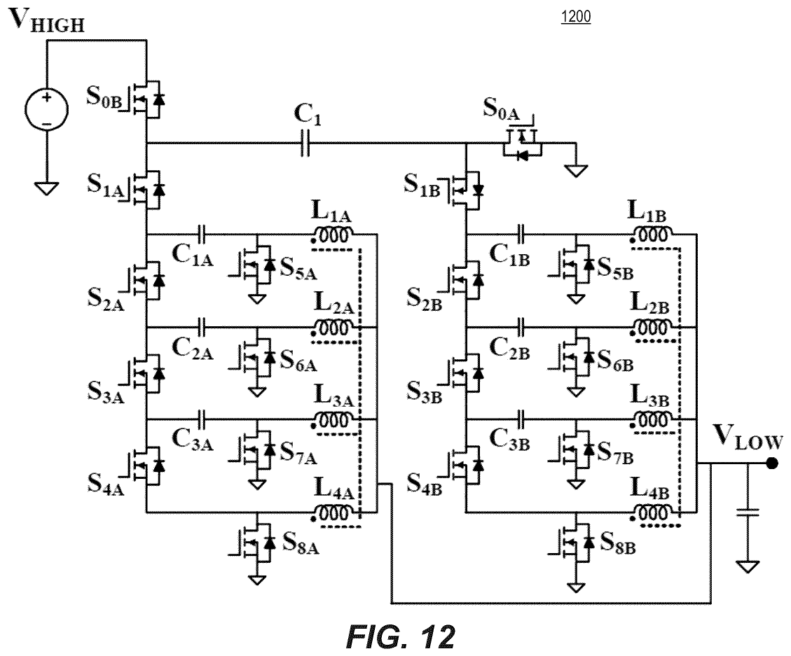

FIG. 12 is a diagram illustrating an exemplary power converter 1200 employing coupled inductors and MOSFET switches, in accordance with some embodiments of the present disclosure. Converter 1200 provides an example topology of a 48 V-1 V basic conversion unit (e.g., converter 900A of FIG. 9A). All switches may be implemented as MOSFETs, Gallium Nitride High Electron Mobility Transistors (GaN HEMTs), and/or other semiconductor switches.

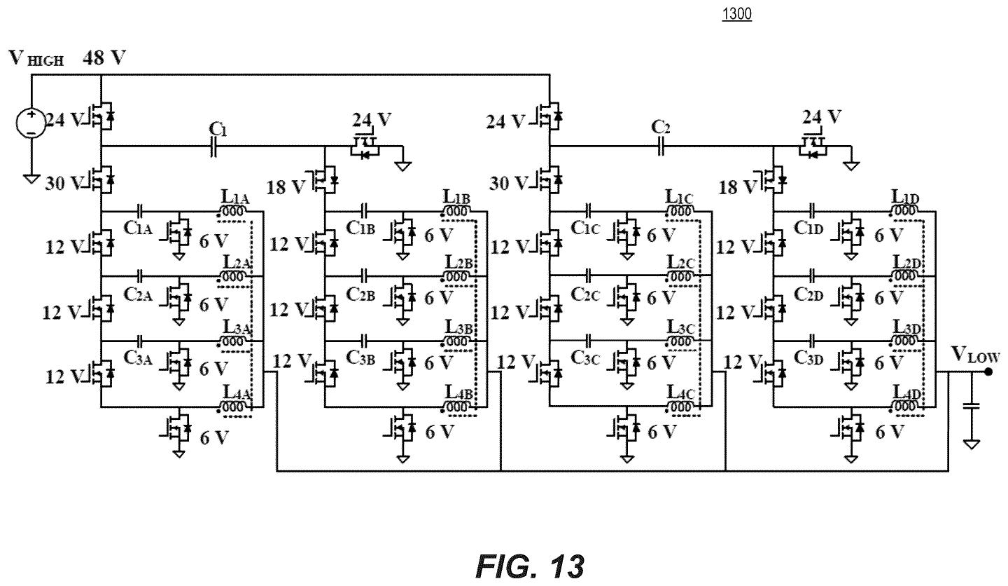

FIG. 13 is a diagram illustrating an exemplary power converter 1300 employing coupled inductors and MOSFET switches, in accordance with some embodiments of the present disclosure. Converter 1300 may provide an example topology of two 48 V-1 V basic conversion units connected in parallel. For example, converter 1300 may provide an example implementation of converter 1000 from FIG.

10. All switches may be implemented as MOSFETs, Gallium Nitride High Electron Mobility Transistors (GaN HEMTs), and/or other semiconductor switches. In one implementation, the voltage ratings of the high side switches of the power converter 1300 may not be symmetric. In another implementation, the voltage ratings of the high side switches of the power converter 1300 may be symmetric. Power converter 1300 may provide the benefits of having a reduced component count in comparison with step-down converters of comparable ratios and/or automatically sharing current.

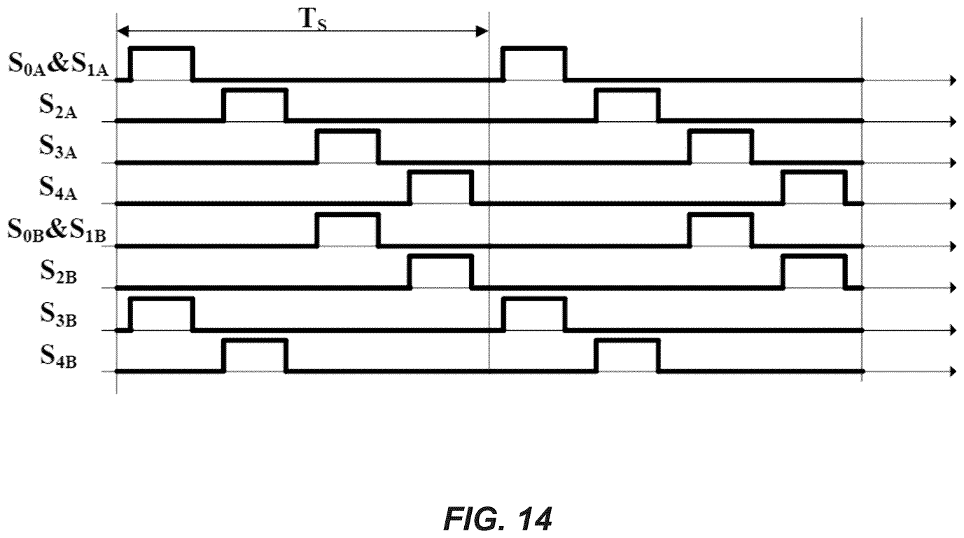

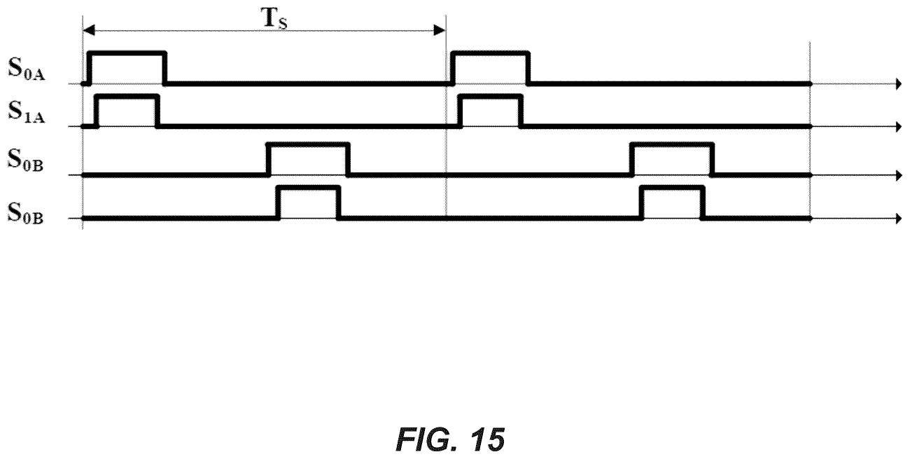

FIGS. 14 and 15 are graphs 1400 and 1500, respectively, illustrating an example operation of the exemplary power converter 1200 of FIG. 12, in accordance with some embodiments of the present disclosure. The continuous time-dependent plots indicate when a switch is in an “on” or electrically conductive state and when it is in an “off” or open circuit state. As shown in graph 1400 of FIG. 4, all switches may operate at the same switching frequency. In order to reduce the output voltage and current ripple, graph 1400 includes four buck phases in one series-capacitor buck voltage regulator operating in an interleaved mode with a 90° phase shift. Further, the two series-capacitor buck voltage regulators may also work in an interleaved mode with a 180° phase shift. The gate driver signals of S0A and S0B of the 2:1 switched capacitor charge distributor may be synchronized to the gate driver signals of S1A and S1B.

Graph 1500 may illustrate a varying deadtime between activation of each switch. Setting proper deadtime as shown in graph 1500 can enable zero-current-switching for lower switching loss.

Disclosed embodiments may address voltage ripple. Considering the circuit topology of converter 1300 of FIG. 13 as the example, the DC voltage rating of the capacitors C1 and C2 in the 2:1 switched capacitor charge distributor may be VHIGH/2, and the DC voltage ratings of the series capacitors may be:
C1A through C1D: 0.375*VHIGH;
C2A through C2D: 0.25*VHIGH; and
C3A through C3D: 0.125*VHIGH.

The average of VIB may be approximately half of the input voltage VHIGH. During normal operation, the capacitors may have voltage ripple, and the amplitude of voltage ripple may depend on the capacitance of the capacitors and the operation status. FIG. 13 includes example DC voltage ratings for the switches in converter 1300 assuming VHIGH=48 V.

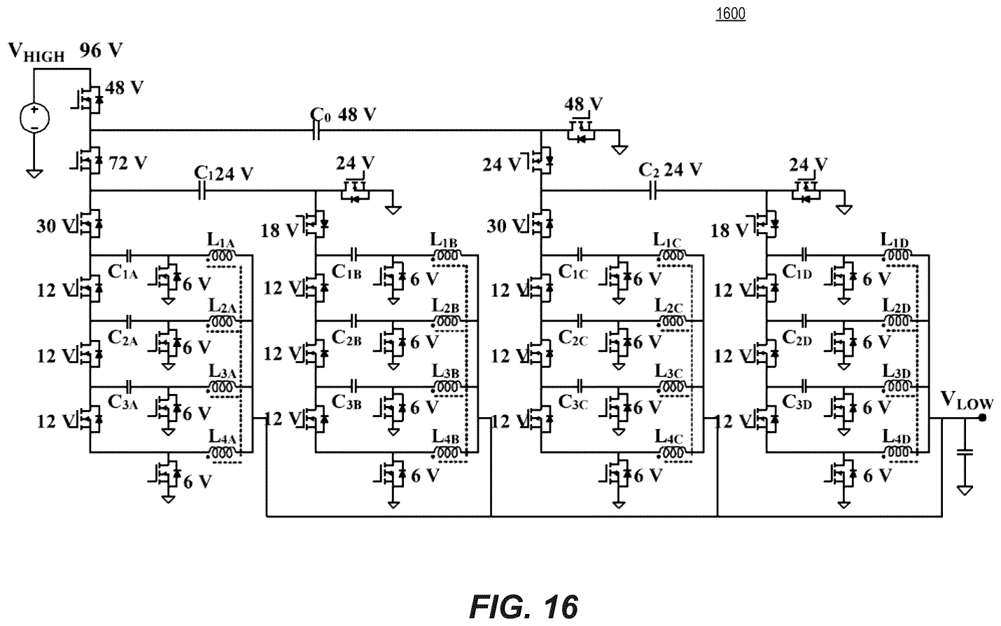

FIG. 16 is a diagram illustrating an exemplary power converter 1600, in accordance with some embodiments of the present disclosure. Converter 1600 includes example voltage ratings for its switches. Similar to FIG. 13, FIG. 16 shows voltage ratings of all switches in an example topology of a 96 V-1 V converter.

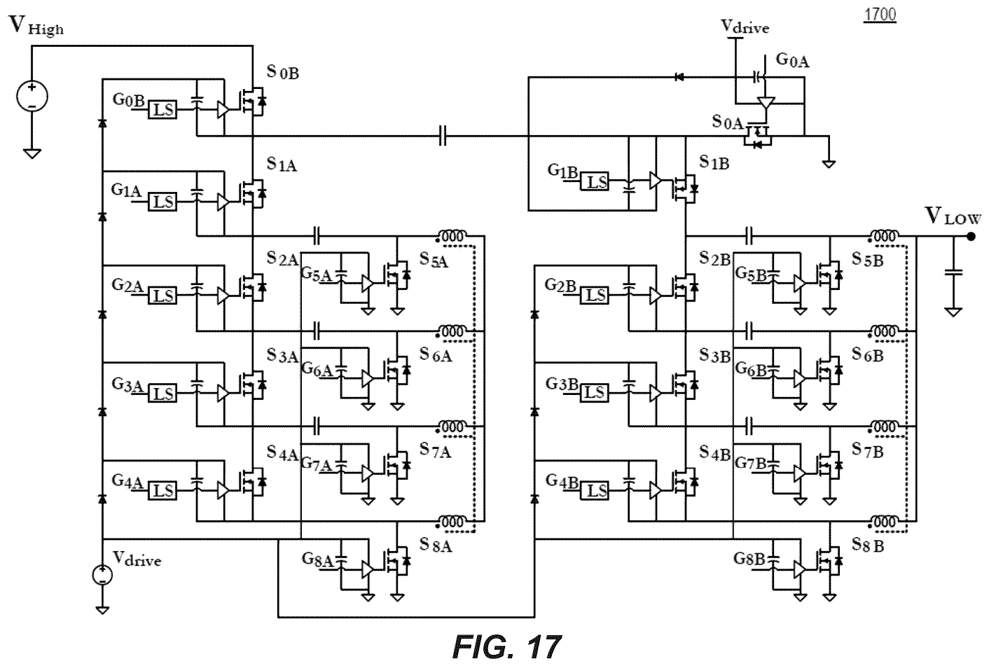

FIG. 17 is a diagram illustrating an exemplary power converter 1700, in accordance with some embodiments of the present disclosure. Converter 1700 provides an example gate driver implementation for the 48 V-1 V basic conversion unit. Converter 1700 may include power delivery paths for each gate driver and the diode bootstrapping chain originating from the VDRIVE nodes. Converter 1700 may also include gate driver control signals G0A through G8B for each switch, which is referred to the ground. Converter 1700 may include level shifters (LS) to transform the signal voltage level for switches with floating source.

A bootstrapping diode may have a forward voltage drop. This voltage drop may accumulate in a long diode chain. To address this issue, disclosed embodiments may modify the original gate driver voltage supply (referred to the ground) to be raised up. This may allow the gate driver voltage supply to have enough gate driver voltage supply for the top switch. in converter 1700. To avoid over-voltage of Vgs, such as for GaN switches, an LDO can be inserted before the gate drivers.

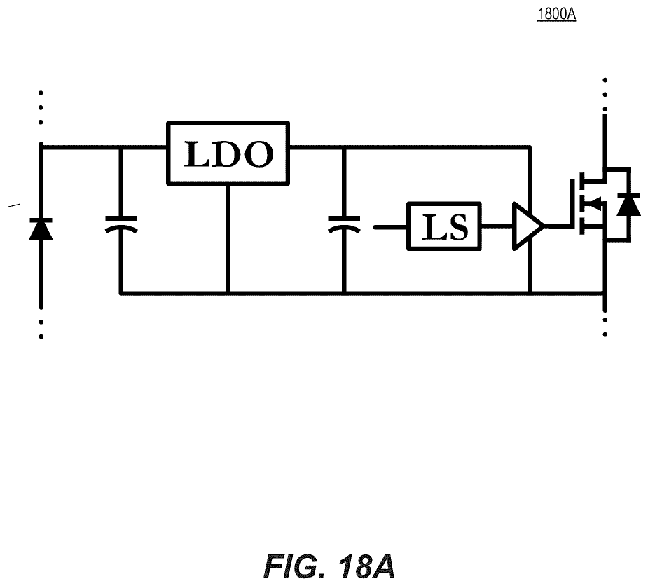

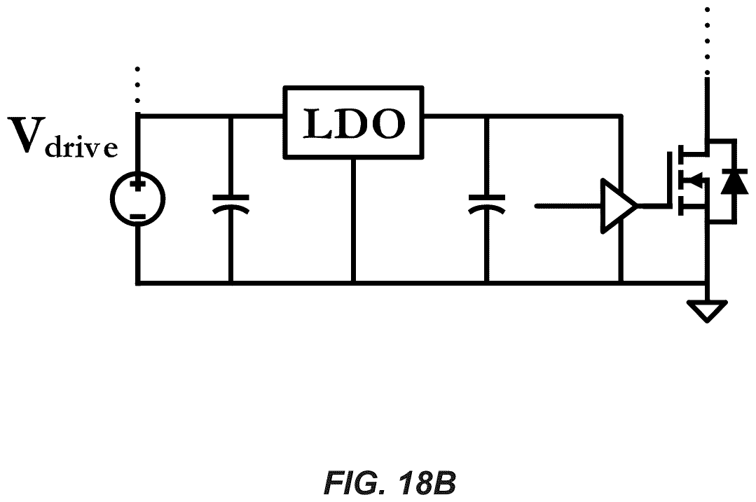

FIGS. 18A and 18B are diagrams illustrating low dropout implementations 1800A and 1800B, respectively, for controlling switches, in accordance with some embodiments of the present disclosure. Implementations 1800A and 1800B may provide example ways to provide switches with a floating source and with a grounded source, respectively.

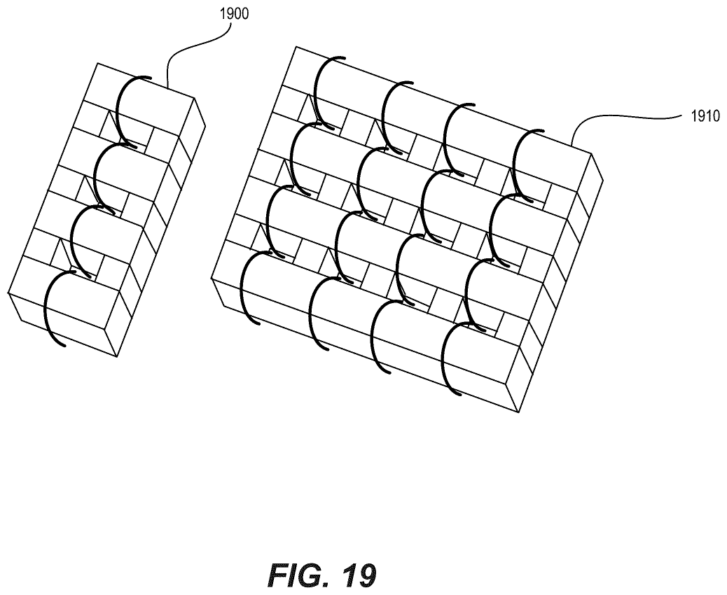

FIG. 19 is a diagram illustrating exemplary coupled inductors 1900 and 1910, in accordance with some embodiments of the present disclosure. Disclosed embodiments may include DC-DC converters that may include magnetic components (e.g., inductors). To improve the overall power density of the converters, disclosed embodiments may employ inductors that are coupled to a common magnetic core. Inductor 1900 provides an example coupled inductor having a four-phase ladder structure (e.g., 4×1). Inductor 1910 provides an example coupled inductor having a 16-phase matrix structure (e.g., 4×4). Although example dimensions of 4×1 and 4×4 are used, other ladder lengths and matrix dimensions may also be used, such as 16×16, 4×8, and 1×16. Although not explicitly enumerated, still other variations on matrix and ladder dimensional ratios may be formed. Such planar 2D structures may be attractive for implementations requiring low height such as laptops and data centers.

For example, a magnetic core may include a first void that forms two lengths of magnetic core material between two ends and electrically conductive windings that wrap the two lengths of magnetic core materials. In some embodiments, the magnetic core may include a second void and a third void in conjunction with the first void, where the first, second, and third voids form four lengths of magnetic core material between the two ends. In some embodiments, a magnetic core may include a plurality of first voids arranged in a first direction (e.g., along a length of the magnetic core) and at least on second void arranged in a second direction perpendicular to the first direction. The plurality of first voids may form a plurality of lengths of magnetic core between two ends in the first direction and electrically conductive windings may wrap the plurality of lengths of magnetic core material.

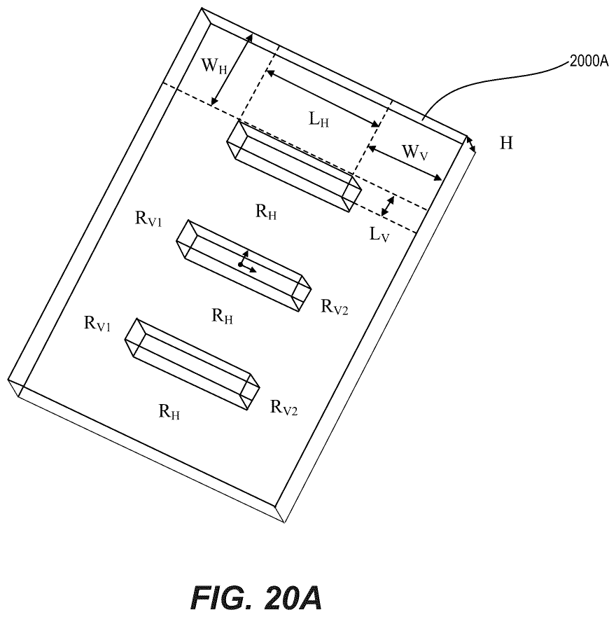

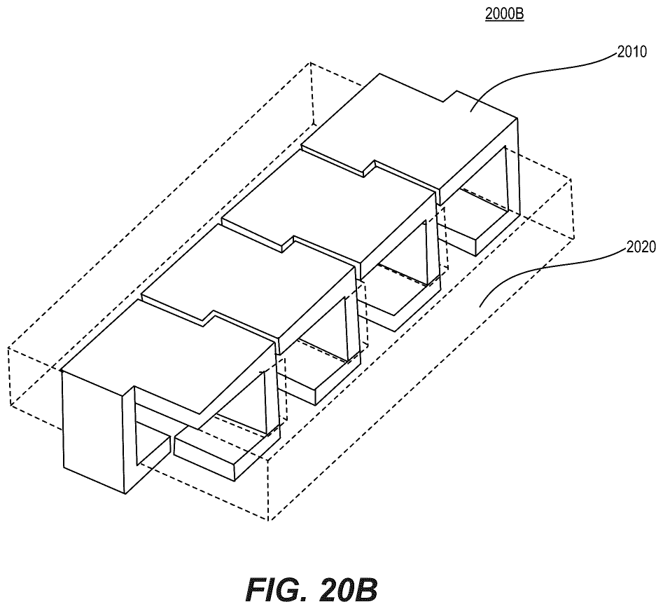

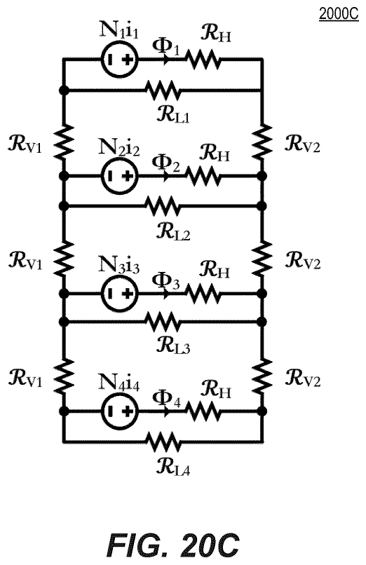

FIGS. 20A, 20B, and 20C illustrate an exemplary coupled inductor, in accordance with some embodiments of the present disclosure. FIG. 20A provides a three-dimensional model of an example ladder core 2000A. For example, as shown, ladder core 2000A may include various length and width dimensions that may be used to identify various regions. As an example, The dimension may be: H=3 mm, LH=6 mm, WH=4 mm, LV=1.2 mm, WV=3 mm. In this example, the core area is 19.6 mm×12 mm=235.2 mm2 and the volume is 19.6 mm×12 mm×3 mm=705.6 mm3. The core material may be ferrite 3F4 having μr=900.

FIG. 20B illustrates coupled inductor 2000B. As shown, inductor 2000B may include four windings 2010, which may wrap the “rungs” of ladder core 2020. In some embodiments, windings 2010 may extend below the bottom face of core 2020. For example, windings 2010 may extend 1 to 10 mm below the bottom of core 2020. In other examples, windings 2010 may extend less than 1 mm. FIG. 20C illustrates an example reluctance model 2000C for the four-phase ladder structure coupled inductor depicted in FIGS. 20A and 20B.

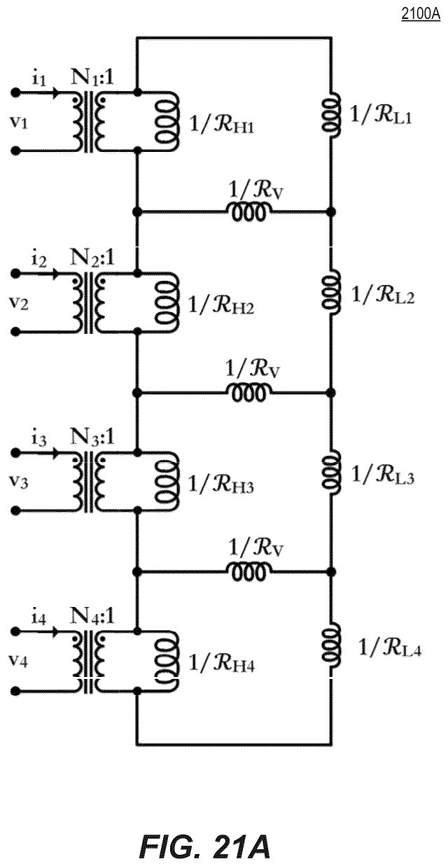

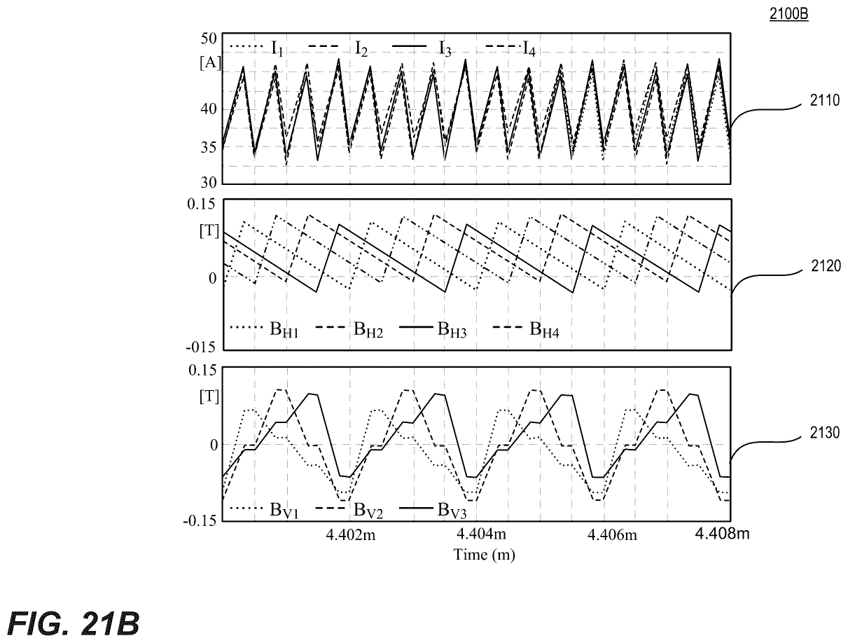

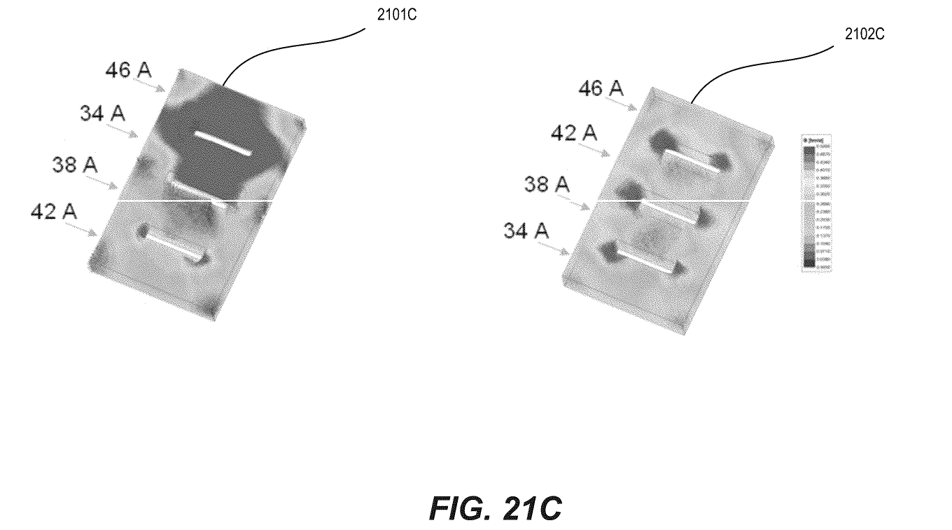

FIGS. 21A, 21B, and 21C illustrate an exemplary coupled inductor, in accordance with some embodiments of the present disclosure. FIG. 21A depicts example inductance model 2100A for coupled inductor 2000B of FIG. 20B. Inductance model 2100A may be formed by converting reluctance model 2000C of FIG. 20C. The reluctance value is extracted by ANSYS simulation: P_{H1}=1.2×10⁶ H⁻¹, P_{L1}=65.4×10⁶ H⁻¹, P_{H2}=0.8×10⁶ H⁻¹, P_{L2}=73×10⁶ H⁻¹, P_{H3}=0.8×10⁶ H⁻¹, P_{L3}=76.1×10⁶ H⁻¹, P_{H4}=1.2×10⁶ H⁻¹, P_{L4}=66.05×10⁶ H⁻¹, Pv=0.236×10⁶ H⁻¹. The inductance dual model can be used in circuit simulation to verify the design. FIG. 21B illustrates a simulation of phase current and the flux density with balanced current in graph 2100B. Graph 2100B includes plot 2110 showing current over time, plot 2120 showing the magnetic B-field strength (e.g., magnetic flux density) over time for the regions corresponding to the “rungs” of the ladder inductor, and plot 2130 showing the magnetic B-field strength over time for the regions along the two “side rails” of the ladder inductor. FIG. 21C illustrates an example ANSYS FEA simulations 2101C and 2102C with unbalanced phase current. The darker shading around the voids between the rungs indicates an increase in the magnetic flux density. The simulation and calculation show this design performs well with balanced phase current. For example, the number of “hot spots” in simulation 2102C is relatively minimal. However, the inductor may be saturated with unbalanced phase current. For example, simulation 2101C includes an upper region where flux density is concentrated.

In some embodiments, coupled inductors may include one or more of the following variations: mixed core materials, windings that form posts that extend orthogonal to the bottom of the core, a core that includes a cap layer that covers (in part or whole) the windings, a cap layer that includes a gap (e.g., to control leakage inductance), windings that tesselate, and/or windings that are adjacent without tessellating. Although not necessarily explicitly depicted in the figures, disclosed embodiments may include all combinations, sub-combinations, and permutations of these features. For example, disclosed embodiments may include a mixed core and a cap layer on top of the core (e.g., with or without a gap) and non-tessellating windings even though this particular combination of features is not explicitly shown together in a given figure.

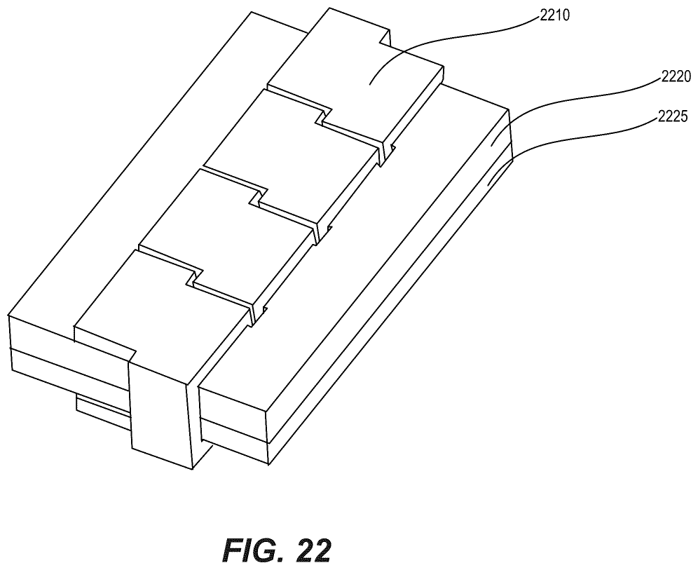

FIG. 22 illustrates an exemplary coupled inductor 2200 with mixed core materials, in accordance with some embodiments of the present disclosure. Inductor 2200 may include a first layer 2220, second layer 2225, and windings 2210. The materials of first layer 2220 and second layer 2225 may both be magnetic, but include different materials. In some embodiments, one of the layers may include a material with high permeability and low saturation capability (e.g., ferrite) and the other layer may include material with lower permeability but higher saturation capability (e.g., iron powder). The use of multiple or different materials may prevent or reduce likelihood of full saturation of the inductor (e.g., material 1 saturates at a higher/lower current than material 2). Coupled inductor 2200 may otherwise be similar to the other four-by-one ladder inductors previous discussed (e.g., as shown in FIG. 19 (inductor 1900), 20A, 20B). First layer 2220 and second layer 2225 may be formed by stacking two thinner plates, which may form an overall height of 3 mm. As an example, the thickness of the powder material may be 1.2 mm. First layer 2220 and second layer 2225 may have the same thickness or different thicknesses. As an example of the layers having differing thicknesses, the thickness of first layer 2220 to the thickness of second layer 2225 may form a 3:1 ratio (e.g., first layer 2220 may have a thickness of 3 mm and second layer 2224 may have a thickness of 1 mm) or vice versa.

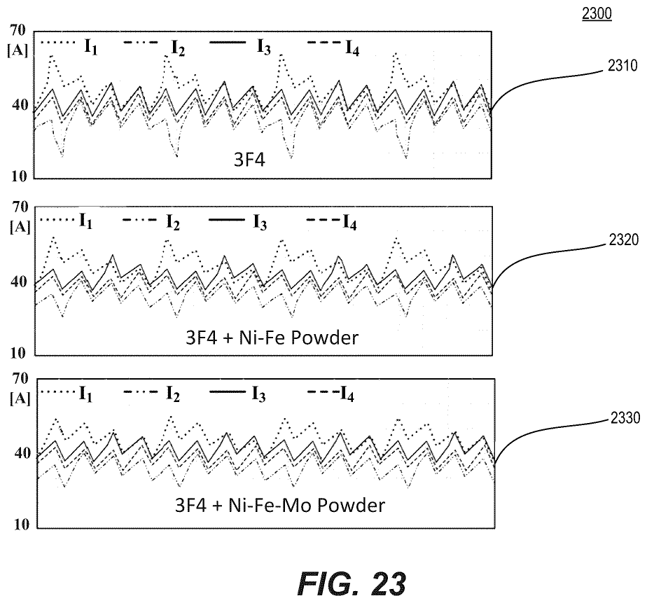

FIG. 23 illustrates graphs 2300 of simulated performance of exemplary coupled inductors, in accordance with some embodiments of the present disclosure. Graphs 2300 may be generated through a PSIM simulation with unbalanced phase current (e.g., I1=46 A, I2=34 A, I3=42 A, I4=36 A). Graphs 2300 may include plot 2310 for 3F4 (e.g., soft ferrite) material core (having only one layer), plot 2320 for a two-layered core made of 3F4 material and Ni—Fe (high flux) powder, and plot 2330 for a two-layered code made of 3F4 material and Ni-Fc-Mo power (e.g., from Metal Powder Products). These simulate plots are based on an overall height of 3 mm. For the two-layer plots, a thickness of 1.2 mm is used for the power material. Along with these example dimensions, the simulation may use the electromagnetic permeability of the High Flux (Ni—Fe) powder (e.g., μr=160) and MPP (Ni—Fe—Mo) powder (e.g., μr=300). Comparing plots 2310, 2320, and 2330 indicates that the two-layer design with mixed materials can reduce current ripple with unbalanced phase current

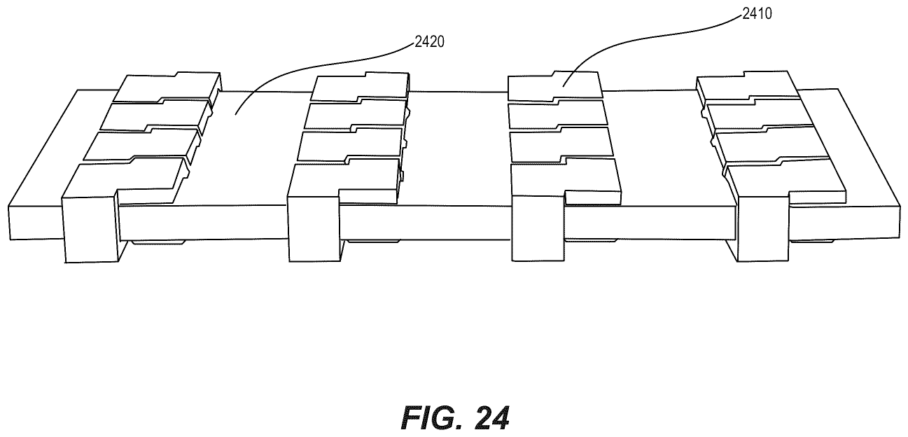

FIG. 24 illustrates an exemplary coupled inductor 2400, in accordance with some embodiments of the present disclosure. Inductor 2400 may be a 16-phase matrix structure coupled inductor (e.g., a 16-phase inductor that may be used in converter 1000 of FIG. 10, converter 1100 of FIG. 11, converter 1300 of FIG. 13, and converter 1600 of FIG. 16). As shown, core 2420 may include openings or voids forming a 3-by-4 grid. This allows for 16 separate windings 2410, forming a four-by-four grid of windings.

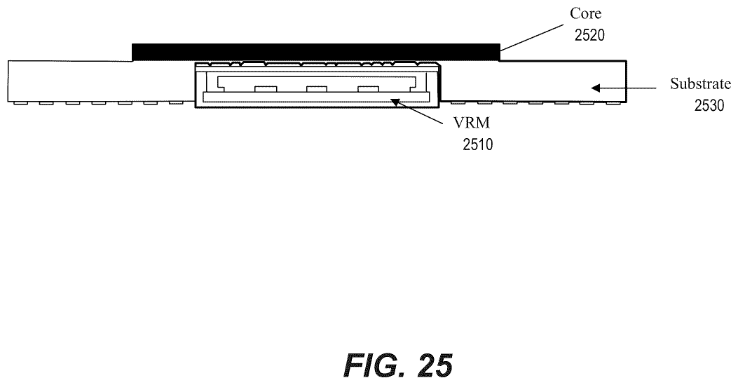

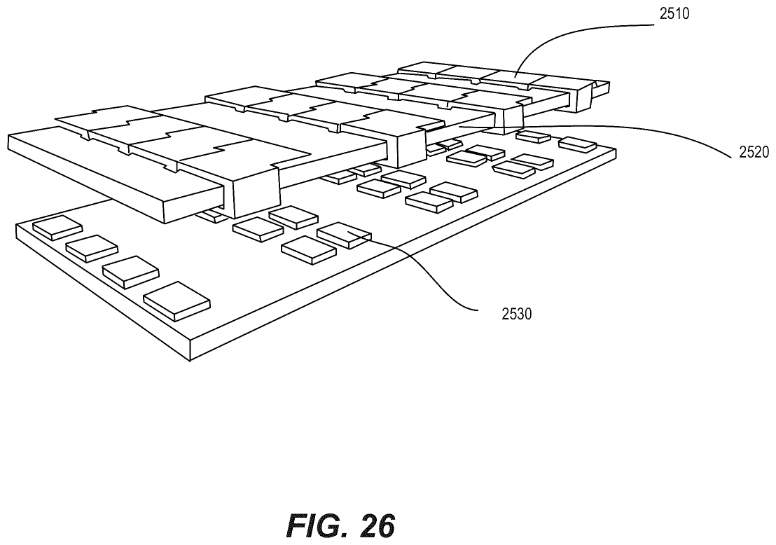

FIGS. 25 and 26 illustrate example systems 2500 and 2600, respectively that include an exemplary coupled inductor, in accordance with some embodiments of the present disclosure.

FIG. 25 illustrates the side view of system 2500 showing its vertical power delivery structure. System 2500 may include voltage regulator module (VRM) 2510, core 2520, and substrate 2530. As shown, VRM 2510 may be directly assembled under the substrate of the CPU. This arrangement may allow power to be delivered from the bottom to the top. The PCB area of VRM 2510 may be reduced or conserved with the vertical power delivery structure.

FIG. 26 illustrates an exploded view of an example VRM 2600 (e.g., VRM 2510). As shown, VRM 2600 may include windings 2510, magnetic core 2520, and switches 2530. The relatively flat design of magnetic core 2520 and windings 2510 allow it to provide a slim overall package, which may permit improved overall power delivery structures.

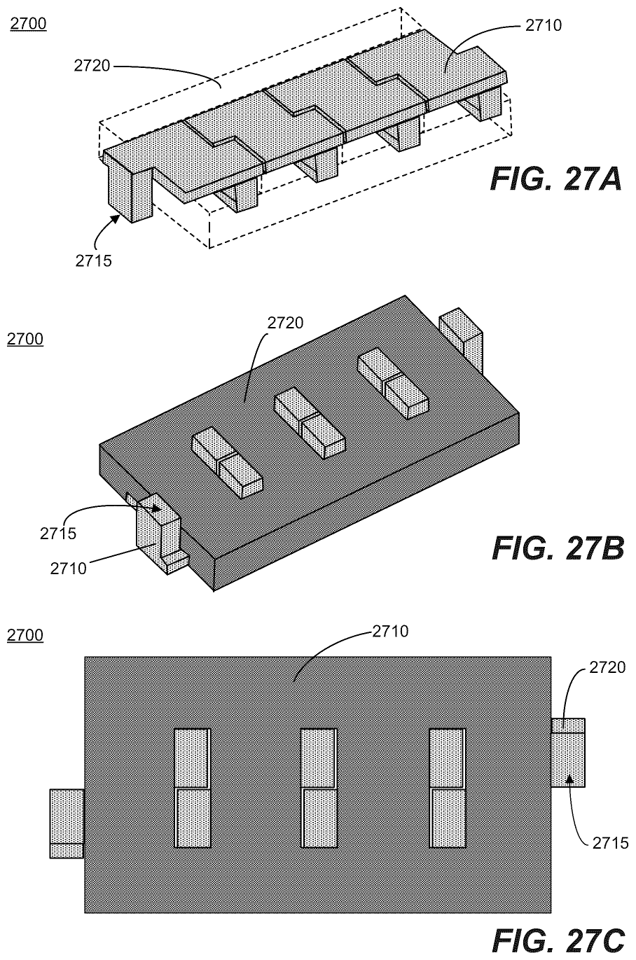

FIGS. 27A, 27B, and 27C illustrate an exemplary coupled inductor 2700, in accordance with some embodiments of the present disclosure. As shown, coupled inductor 2700 provides an example of a coupled inductor windings that form posts that extend orthogonal to the bottom of the core. Coupled inductor may include magnetic core 2720 and windings 2710. In some embodiments, magnetic core 2720 may include a mix of materials as previously discussed. In some embodiments, windings 2710 may form posts 2715. Post 2715 may extend orthogonally from the bottom of magnetic core 2720. For example, posts 2715 may extend 1 to 10 mm from the bottom of magnetic core 2720. Posts 2715 may advantageously allow coupled inductor 2700 to be attached above a circuit board. For example, posts 2715 may connect to a printed circuit board (PCB) while also permitting coupled inductor 2700 to be offset from the PCB such that other components may be attached to the PCB between the PCB and the body of coupled inductor 2700. This may be particularly beneficial in applications where the footprint permitted for the PCB is limit and/or where vertical displacement is more desirable than occupying space horizontally.

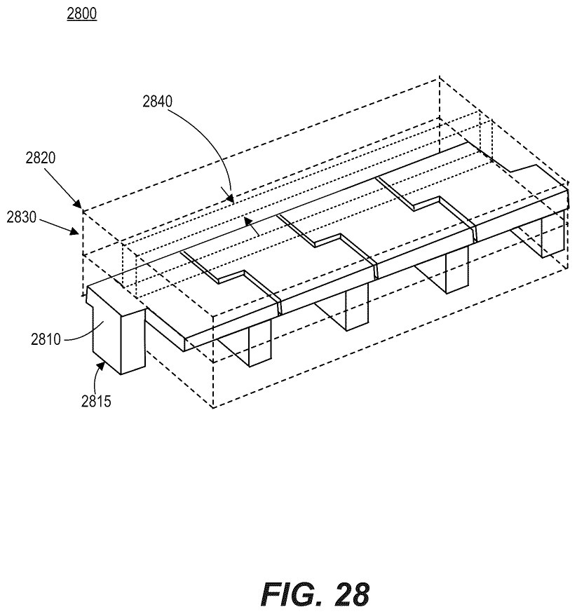

FIG. 28 illustrates an exemplary coupled inductor 2800, in accordance with some embodiments of the present disclosure. As shown, coupled inductor 2800 provides an example of a coupled inductor including a cap layer (alternatively referred to as a cap structure) on the magnetic core. In some embodiments, coupled inductor 2800 may include magnetic core 2820 and windings 2810. As shown, windings 2810 may form posts 2815. Post 2815 may extend orthogonally from the bottom of magnetic core 2820, as previously discussed in relation to posts 2715 of coupled inductor 2700 of FIGS. 27A, 27B, and 27C. Magnetic core 2820 may include cap layer 2830, which may cover windings 2810. Cap layer 2830 may be made of the same material as magnetic core 2820. In some embodiments, cap layer 2830 may include gap 2840, which may be a void or absence of material across cap layer 2830. Gap 2840 may permit tuning of coupled inductor 2800 to desired performance characteristics. For example, gap 2840 may vary in width to adjust the leakage current of coupled inductor 2800.

In some embodiments, coupled inductor 2800 may not include gap 2840. For example, cap layer 2830 of magnetic core 2820 may form a continuous cap layer without gaps, breaks, or voids. Having cap layer 2830 may advantageously allow for coupled inductor 2800 to have a high coupling factor and low leakage inductance. These qualities may allow coupled inductor 2800 to facilitate a large amount of filtering while avoiding slowing a system (e.g., a power converter).

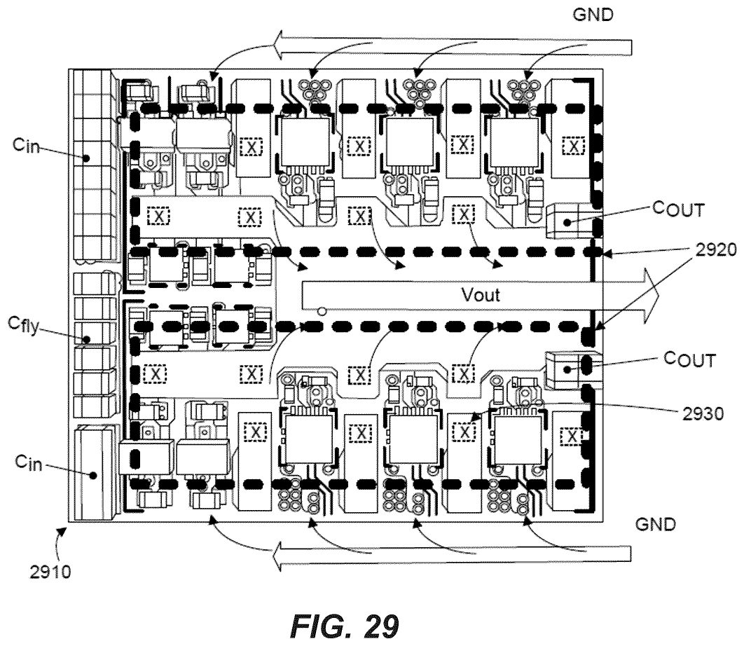

FIG. 29 illustrates an example power converter 2900 for receiving a coupled inductor, in accordance with some embodiments of the present disclosure. As shown, power converter includes capacitors C_OUT, C_fly, and C_in attached to a PCB. Power converter may include ground connections on the upper and lower edges and produce an output voltage on a pad running horizontally across the middle of the PCB. Power converter 2900 may include one or more coupled inductors, marked by footprint outlines 2920. The coupled inductors may include windings having a post design, shown with winding post attachment points 2930. Having a post design for the windings may allow the coupled inductor(s) to be offset from, and sit on top of, the PCB such that other components (e.g., C_OUT) may be attached to the PCB between the PCB and the body of the coupled inductor. This may be particularly beneficial in applications where the footprint permitted for the PCB is limit and/or where vertical displacement is more desirable than occupying space horizontally.

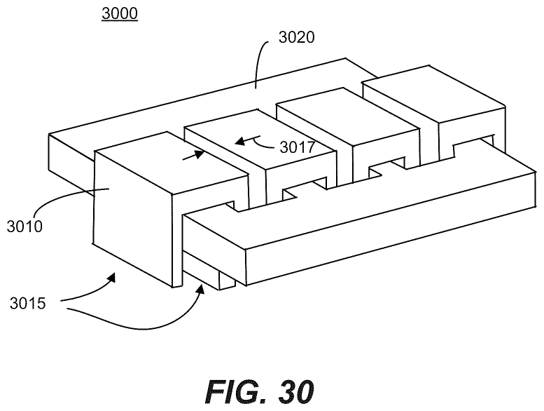

FIG. 30 illustrates an exemplary coupled inductor 3000, in accordance with some embodiments of the present disclosure. Coupled inductor 300 may include magnetic core 3020 and windings 3010. Windings 3010 may include posts 3015 (as shown) and/or include additional material to wrap and cover the bottom face of magnetic core 3020 (not shown). Posts 3015 may, for example, extend 1 to 10 mm from the bottom of magnetic core 3020. Posts 3015 may advantageously allow coupled inductor 3000 to be attached above a circuit board.

As shown, coupled inductor 3000 provides an example of a coupled inductor including non-tessellating windings. As opposed to having adjacent windings that interleave so that the posts form a grid-like pattern (e.g., as shown through the layout of posts 2715 in FIGS. 27B and 27C, and winding post attachment points 2930 in FIG. 29), windings 3010 of coupled inductor 3000 may be run the entire length of the voids in magnetic core 3020, being separated by lateral spacing 3017. This arrangement of windings 3010 may advantageously allow of alternative post mounting points, which may provide desirable alternative layout possibilities for an associated PCB.

The design of windings 3010 may be combined with other combinations and permutations of features previously discussed in relation to other embodiments. For example, although not shown, magnetic core 3020 may include a cap layer (e.g., with or without a gap). Magnetic core 3020 may also include a mix of materials, as previously discussed.

With the growth of cloud computing and AI applications, the computing power consumption has also increased significantly. High-performance microprocessors with billions of transistors can consume hundreds of amperes of current at very low voltages, e.g., <1V. Ultra-thin voltage regulation modules with miniaturized z-height may be desirable for enabling ultra-compact power on-package system with reduced interconnection lengths, improved signal integrity, as well as increased efficiency, density, and control bandwidth.

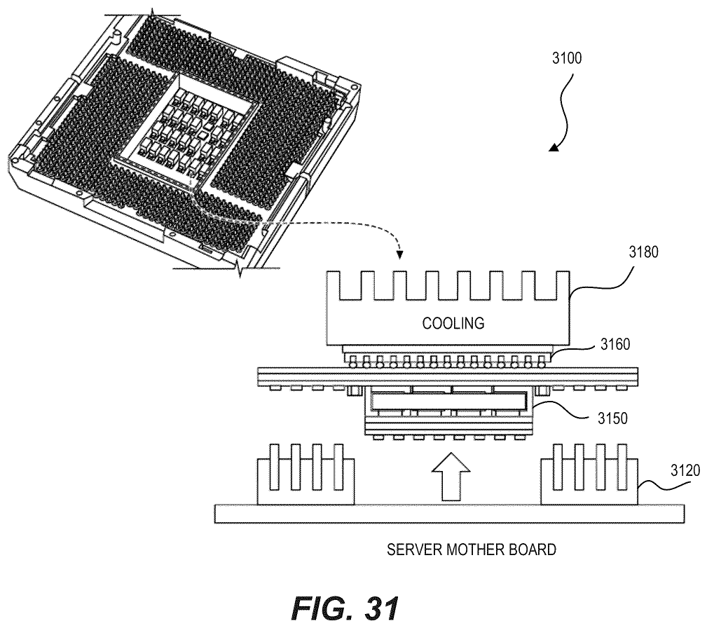

FIG. 31 illustrates a schematic of an exemplary voltage regulator module (VRM) embedded in package with a microprocessor, in accordance with some embodiments of the present disclosure. System 3100 may include a server mother board, a socket 3120, a VRM 3150, an application specific processing unit architecture (XPU) 3160, and a cooling mechanism 3180. The height of the voltage regulation module may be influenced by the height of magnetic components such as, but not limited to inductors or coupled inductors. The height of the magnetic components may be determined by the tradeoff between transient and ripple performance.

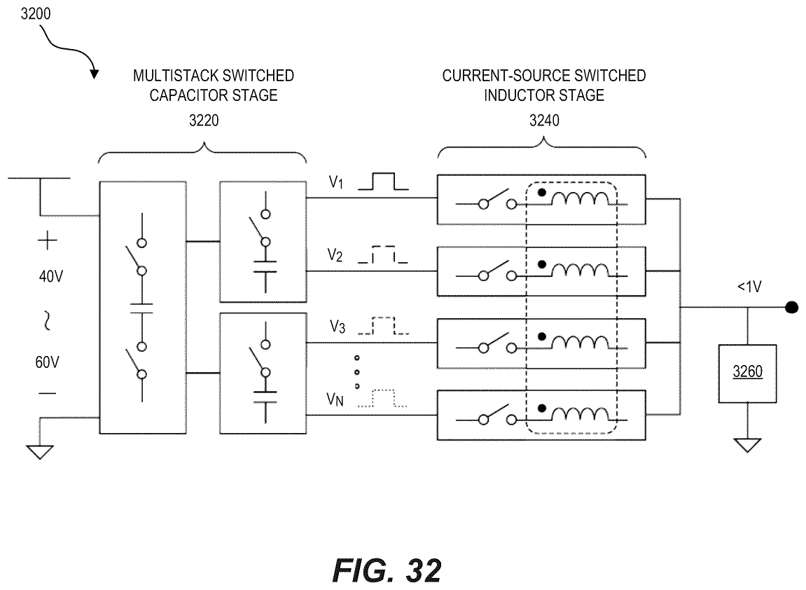

FIG. 32 illustrates a schematic of an exemplary architecture for a microprocessor VRM, in accordance with some embodiments of the present disclosure. Architecture 3200 may be a multistack switched-capacitor point-of-load (MSC-POL) architecture with coupled magnetics for 48 V-to-1 V microprocessor voltage regulation and may include a multistack switched capacitor stage 3220, a current-source switched inductor stage 3240, and a processing unit 3260.

In some embodiments, as illustrated in FIG. 32, multiple SC cells are stacked in front and break down the high input voltage into many intermediate voltage rails, which are loaded with switched-inductor current sources to perform soft charging and voltage regulation. Different from IBA topologies, the intermediate voltage rail herein is not necessarily a fixed de bus but may shift between several de levels at different switching states. The de rail voltage is provided by the capacitor network of the SC stage, and thus large intermediate bus capacitor can be eliminated. The switched-inductor cell is switched in at an appropriate time to get the desired voltage level. Many inductors of the switched inductor cells are merged into one and operated in interleaving. Through soft charging multiple switched capacitors with one single coupled magnetic component, the MSC-POL architecture can minimize both capacitor and magnetic size, achieving extremely low z-height together with high efficiency and high transient speed.

As discussed earlier, the height or compactness of the voltage regulation module (VRM) may be determined in part by the dimensions of the magnetic components. To achieve ultra-low z-height, improvements in both power architecture and magnetics may be desired. A widely adopted 48 V-to-1 V regulation solution is the two-stage intermediate bus architecture (IBA), where the first stage is usually a transformer-based converter (e.g., LLC converter) or a switched-capacitor (SC) circuit functioned as a fixed-ratio de transformer (DCX), and the second stage is a multiphase buck switching at high frequencies for high control bandwidth. Compared to transformer-based topologies, SC converters utilize capacitors to undertake the major voltage stress for the large step-down ratio and can greatly decrease the converter size due to the superior capacitor energy storage density. Soft charging technique can be leveraged on SC circuits to reduce the charge sharing loss, allowing to use lower switching frequency or smaller capacitors for higher power density and efficiency. In terms of magnetic components, the height is limited by the fundamental trade-off between transient and ripple performance. Coupled magnetics with interleaving operation can obtain both high di/dt in transient and low current ripple in steady state, significantly reducing the de energy storage and magnetic size.

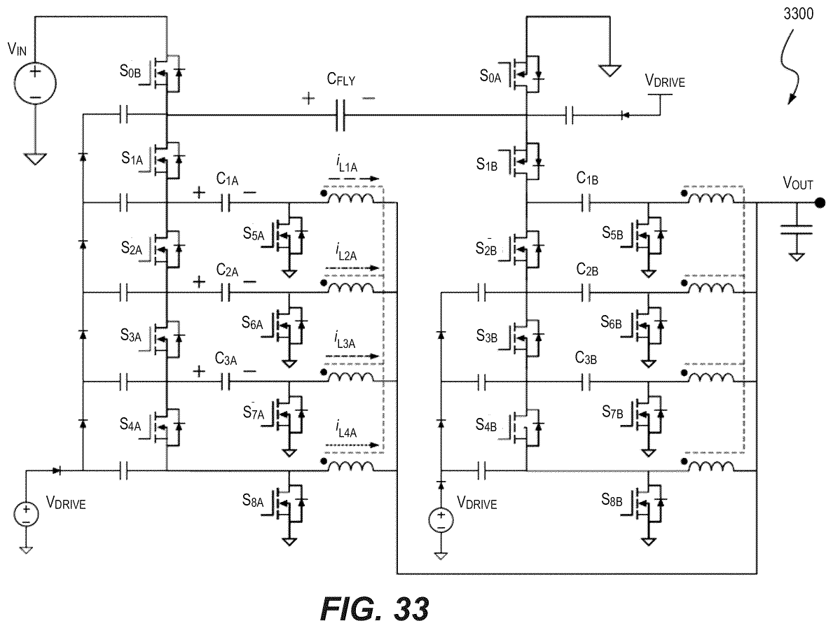

FIG. 33 illustrates a schematic of the topology of an exemplary architecture for a microprocessor VRM, in accordance with some embodiments of the present disclosure. Architecture 3300 may comprise a H-bridge SC cell and two 4-phase series-capacitor buck (SCB) modules. The stacked H-bridge SC cell is configured to step down the Vin by half and distributes 24 V to the first phase of each SCB module. Two switches at the output terminal of the H-bridge may be merged with the input switches of SCB modules to reduce component count and power loss. Architecture 3300 may further include one or more bootstrap gate drive circuits. It is to be appreciated that the topology illustrated in FIG. 33 is a non-limiting exemplary implementation of the MSC-POL architecture, and other topologies and configurations are possible as well. For example, two or more H-bridges or parallel more buck phases for extended voltage conversion ratios or higher power ratings may be employed.

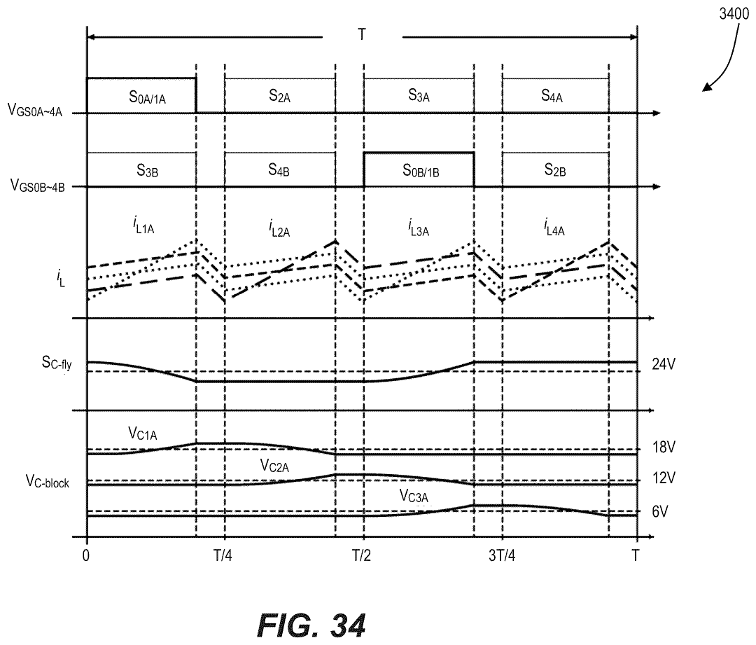

FIG. 34 illustrates exemplary operation waveforms for a microprocessor VRM based on multistack switched-capacitor point-of-load (MSC-PoL) architecture, in accordance with some embodiments of the present disclosure. Plot 3400 shows the operation waveforms of a 48 V-to-1 V MSC-POL converter. Switches S_{0A} and S_{0B} may be synchronized with S_{1A} & S_{1B}, respectively. For each SCB module, high-side and low-side switches of one phase are driven by complementary gate signals and four phases may be interleaved by 90° phase-shifts.

In some embodiments, the four interleaving operated inductors in each SCB module may be parallel-coupled into one, resulting in reduced inductor current ripples with 4X ripple frequency, as shown in FIG. 34. As an example, as illustrated in FIG. 34, two SCB modules may be phase-shifted by 180°. The flying capacitor Cfly in the SC cell is soft charged and discharged in turns by phase 1A and phase 1B of the two SCB modules, while the blocking capacitors C1˜3A/B in the SCB circuits may be soft charged and discharged by the inductor currents of two neighboring phases. In some embodiments, automatic mutual balancing of capacitor voltages and inductor currents can be achieved during charge & discharge processes.

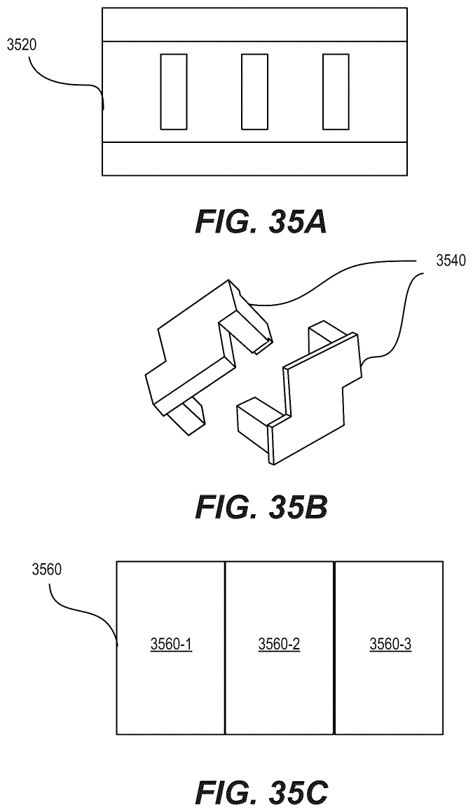

FIGS. 35A, 35B, and 35C illustrate schematics of an exemplary coupled inductor with a ladder core, windings, and magnetic plate, respectively, in accordance with some embodiments of the present disclosure. FIG. 35A illustrates a top view of a ladder core 3520 of a prototype of a coupled inductor. To minimize the z-height, a four-phase ladder-structured coupled inductor with windings 3540 (as shown in FIG. 35B) may be used. In a preferred embodiment, windings 3540 may be machined with a computer numerical control (CNC) machining system. Coupled inductor may further comprise a plate 3560, an example of which is shown in FIG. 35C. Plate 3560 may be configured to reduce the reluctance of leakage flux path and may be placed on top of the ladder-core 3520. In the context of this disclosure, plate 3560 may be referred to as a leakage magnetic plate. The reduced reluctance of leakage flux path may result in increased leakage inductance, decreased current ripple, and improved efficiency. The inventors recognize that adding the leakage plate may result in slower transient speed and higher thickness. Simulated transient inductance Lₜᵣ, steady state inductance Lₛₛ, and magnetic height of the two coupled inductor designs are summarized in Table 1 below.

TABLE 1
Comparison of two coupled inductor designs.

| Coupled Inductor Design | Lₜᵣ | Lₛₛ | Height |
|---|---|---|---|
| Ladder Core only | 14 nH | 127 nH | 2.9 mm |
| Ladder Core + Leakage Plate | 67 nH | 410 nH | 4.2 mm |

In some embodiments, windings 3540 may be made from a magnetic material including, but not limited to, copper, aluminum, or other suitable materials. In some embodiments, ladder-core 3520 may be made from Fair Rite 79® or other suitable materials. In a preferred embodiment, the dimensions of ladder-core 3520 may be 24.1 mm (length)×13 mm (width)×2.9 mm (height). In a preferred embodiment, leakage magnetic plate 3560 may be made from Ferroxcube 3F45. It is to be appreciated that the dimensions, and the materials, are exemplary and non-limiting and may be adjusted, as appropriate. In some embodiments, geometries of the ladder core and CNC windings may be optimized to minimize the sum of core and conduction losses. In some embodiments, the material, dimensions, geometries of ladder-core 3520 and windings 3540 may be optimized based on desired performance metrices.

In some embodiments, plate 3560 may comprise one or more plates 3560-1, 3560-2, and 3560-3 placed adjacent to each other. In some embodiments, the gap between plates 3560-1-3560-3 may be adjusted. In some embodiments, there may be substantially no gap between the plates.

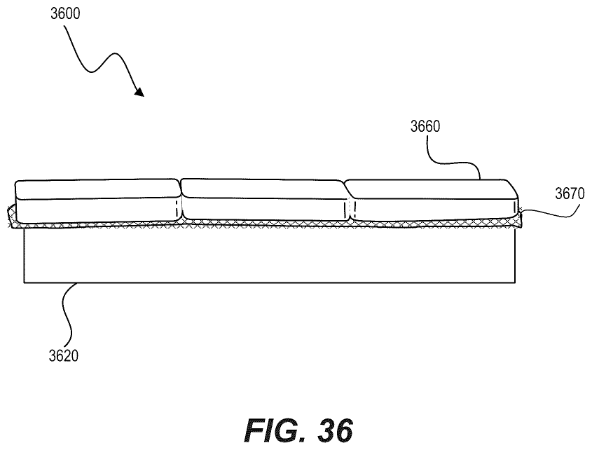

FIG. 36 illustrates an exemplary coupled inductor 3600, schematic of an exemplary coupled inductor including an air gap, in accordance with some embodiments of the present disclosure. Coupled inductor 3600 may include ladder-core 3620, a leakage magnetic plates 3660, and a non-magnetic layer 3670 placed between ladder-core 3620 and leakage magnetic plates 3660. In the context of this disclosure, non-magnetic layer 3670 may be referred to as an “air-gap.” The thickness of non-magnetic layer 3670 (i.e., the air-gap) may be adjusted to achieve a desired leakage inductance.

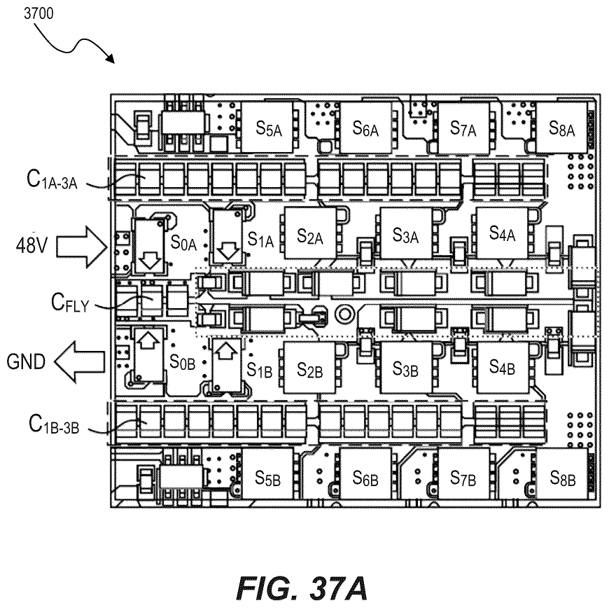

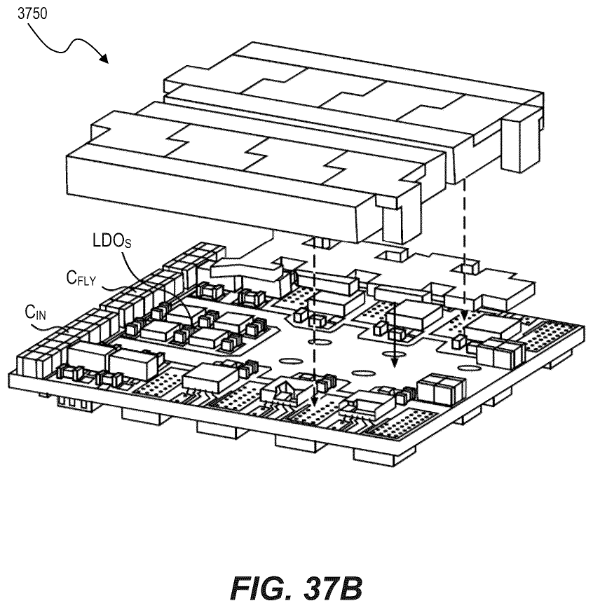

FIGS. 37A and 37B illustrate schematics of a top view and a bottom assembly view, respectively, of an exemplary MSC-POL architecture for a microprocessor VRM, in accordance with some embodiments of the present disclosure. FIG. 37A illustrates a top view 3700 showing detailed component placement and printed circuit board (PCB) layout of a 48V-1V MSC-POL prototype.

In some embodiments, as illustrated in FIG. 37B, all power devices may be placed on the top side of the PCB, while the coupled inductors and gate drivers may be stacked on the bottom side. Placing all power components on one side may simplify the cooling requirements by enabling single-sided cooling. On the prototype, as illustrated in FIG. 37A, the bootstrap circuit chain may be placed in the center, and on its two sides symmetrically locates the H-bridge SC cell as well as the two SCB modules (module S_{A} and S_{B}). To minimize both converter height and on-board area, a stacked inductor-driver structure may be implemented, as shown in FIG. 3750. On the bottom side of the PCB, the coupled inductors may be stacked on top of the gate drivers with a copper backbone inserted in between to draw the high output currents out. Winding structures of the two inductors may be in symmetry to bring all the output currents to the same side, which may enable shortening the layout length of PCB traces and thus reduce the conduction loss of the overall system.

Table 2 tabulates key parameters of the components used in the 48V-to-1V MSC-POL prototype. GaN switches with higher voltage ratings are used for S₀˜1 A/B in the SC cell to undertake high voltage stress; Silicon MOSFETs with lower voltage ratings are used for S₂˜8 A/B in the SCB modules to undertake high current stress. The hybrid GaN-Si switch combination takes the best advantages of material characteristics and current processing techniques of GaN transistors and Silicon MOSFETs.

TABLE 2
Bill-of-Material of the 48 V-1 V MSC-PoL Prototype

| Device & Symbol Description | Description |
|---|---|
| Switches, S₀~1A/B | EPC 2065 |
| Flying Capacitor, C_{fly} | TDK |
| | C2012X5R1V226M125AC |
| Gate Driver for S₀~1A/B | ADI LTC4440-5 |
| High-Side Switches, S₂~4A/B | Infineon BSZ031NE2LS5 |
| Low-Side Switches, S₅~8A/B | Infineon BSZ011NE2LS5I |
| Blocking Capacitors, C₁~3A/B | TDK |
| | C2012X5R1E226M125AC |

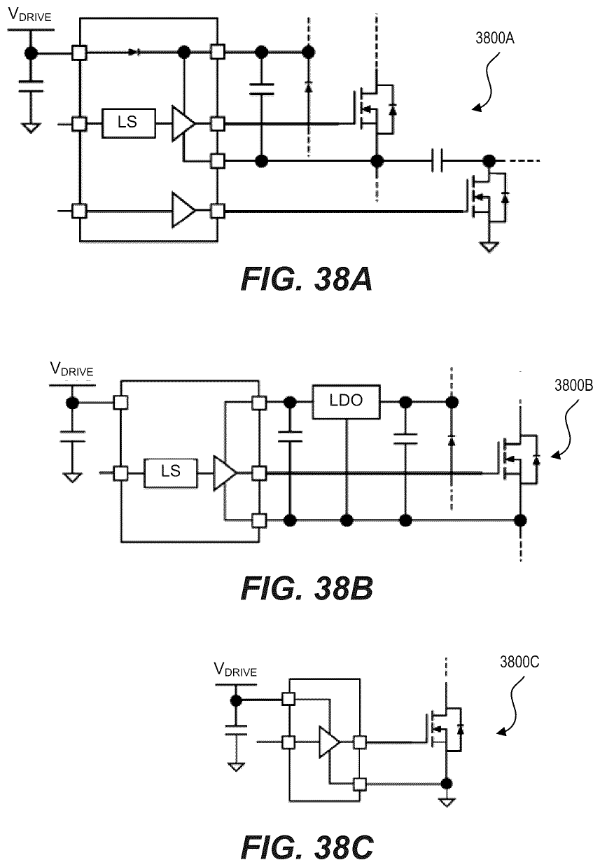

FIGS. 38A, 38B, and 38C illustrate schematics of exemplary circuit designs for switches in MSC-POL architecture for a microprocessor VRM, in accordance with some embodiments of the present disclosure. Circuit 3800A illustrates an exemplary layout of the high-side and low-side switches in the SCB phases 2A˜4A and 2B˜4B, circuit 3800B illustrates an exemplary layout of GaN switches in the SC cell, and circuit 3800C illustrates an exemplary layout of low-side switches in the SCB phases 1A and 1B.

In the embodiments shown in FIGS. 38A-38C, the signal input side may be powered by ground-referenced voltage source V_{drive} ranging from 8 V to 12 V, and the driving output side may be powered by floating DC voltage levels on the bootstrap chain or by V_{drive} if it is ground-referenced. In some embodiments, for GaN switches, a low-dropout regulator (LDO) may be needed to create a stable 5 V voltage rail for the gate drive with overvoltage protection.

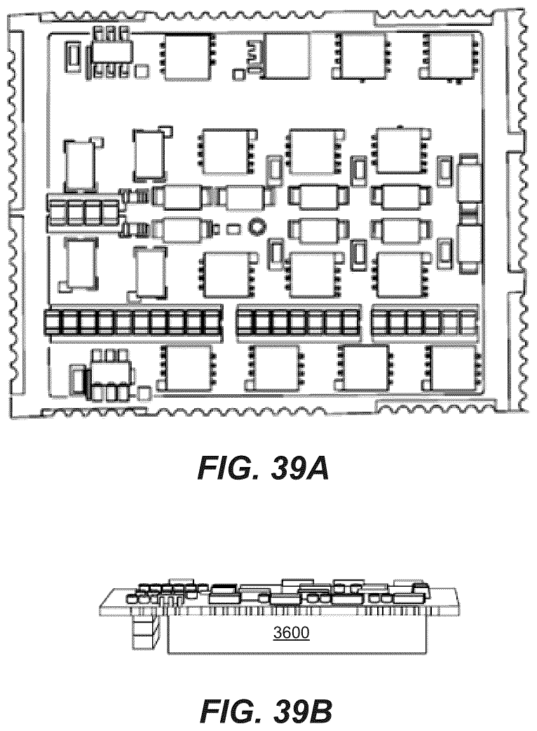

FIGS. 39A and 39B illustrate schematics of top view and a side view, respectively, of hardware layout of an exemplary VRM, in accordance with some embodiments of the present disclosure. In some embodiments, the MSC-POL prototype, as shown in FIGS. 39A and 39B, may be enclosed within a 31.9 mm 26.6

mm 6 mm box volume. All components including power stage, gate driver, and bootstrap circuits as well as coupled inductors may be packaged into a 1/16-brick module with 0.31 in³ ultra-compact size and 6 mm ultrathin thickness. Only pulse-width modulation (PWM) control pins and a voltage rail V_{drive} may be needed for operating the MSC-POL module.

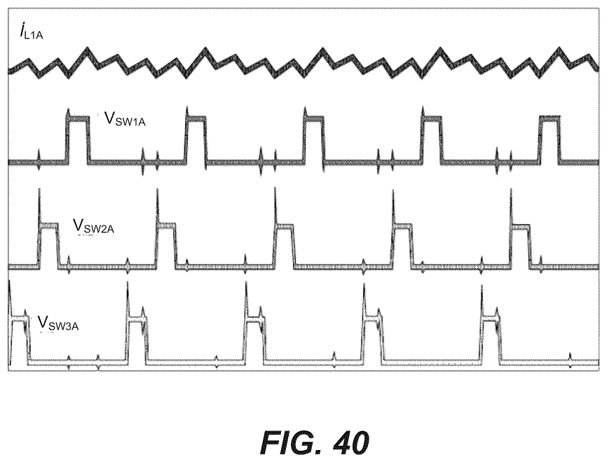

FIG. 40 illustrates a plot of measured inductor current and switched node voltages of an exemplary coupled inductor, in accordance with some embodiments of the present disclosure. The data plot shown in FIG. 40 shows the measured waveforms of example inductor current and switched node voltages at 48 V-to-1 V voltage conversion and 500 kHz switching frequency, validating the functionality of the MSC-POL prototype. The coupled inductor current that was measured with an external measurement loop is in piecewise shape with reduced current ripple and 4× of the switching frequency, as expected. As illustrated, the data plot labeled iL1A indicates the measured inductor current, data plots labeled V_{sw1A}, V_{sw2A}, and V_{sw3A} indicate the switched node voltages, Vin=48 V, Vout=1V, fsw=500 kHz, and Lₛₛ=416 nH. It is to be appreciated that the inductance Lₛₛ may be influenced by the current measurement loop inductance.

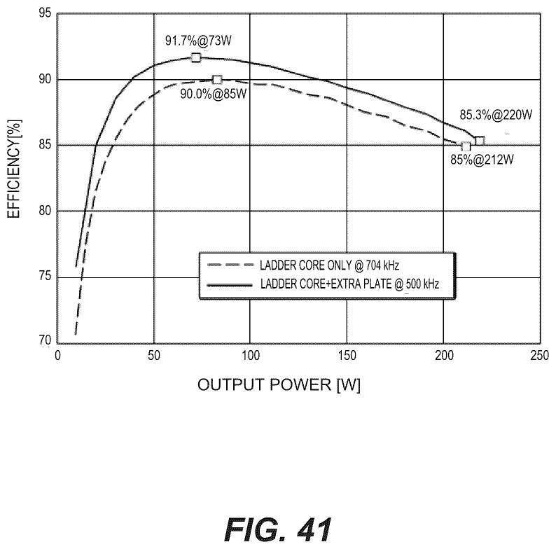

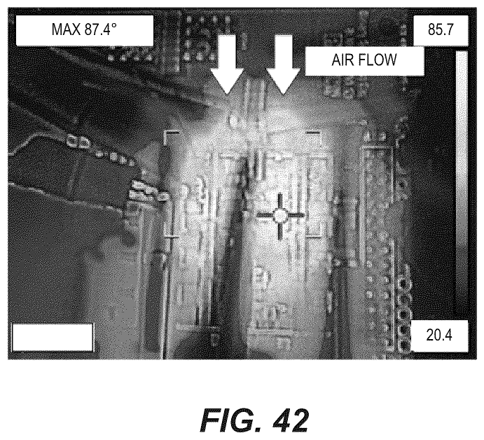

FIG. 41 illustrates a plot comparing the conversion efficiency of exemplary coupled inductors, in accordance with some embodiments of the present disclosure. The plot shown in FIG. 41 shows the measured efficiency when delivering power from 48 V to 1 V with different coupled inductor designs. The inductor design with the leakage plate has a higher leakage inductance and lower current ripple. The resulting smaller RMS and peak current values reduce the conduction loss, switching loss, and parasitic inductance loss, improving the converter efficiency. As shown in FIG. 41, the converter peak efficiencies with and without using the leakage plate are 91.7% and 90.0%, respectively, and the full-load efficiencies are 85.3% and 85.0%, respectively. The maximum output power in each case may be obtained when the hot-spot temperature reaches around 87° C. under 36 CFM fan, as demonstrated in the hot-spot temperature profile in FIG. 42.

Table 3 compares the converter performance when using different coupled inductor designs. The prototype when only using the ladder core can achieve over 680 W/in³ power density at full load. As for the design with the leakage plate, the tradeoff for a higher efficiency is the increased height and converter volume, leading to a slightly decreased 580 W/in³ power density. Benefiting from the multistack SC architecture, soft charging technique, hybrid GaN-Si switch combination, and coupled magnetics, the 48V-1V MSC-POL prototype achieves an ultracompact size at an extremely low z-height, together with high efficiency and high transient speed.

TABLE 3
Converter Performance Comparison

| | | | Ladder Core + | |
|---|---|---|---|---|
| | Ladder Core Only | | Leakage Plate | |
| Converter Height | 6 | mm | 7.3 | mm |
| Box Volume | 0.310 | in³ | 0.377 | in³ |
| Peak Efficiency | 90.0% | | 91.7% | |
| Peak Efficiency Power Density | 274 | W/in³ | 194 | W/in³ |
| Full-Load Efficiency | 85.0% | | 85.3% | |
| Full-Load Power Density | 684 | W/in³ | 584 | W/in³ |

In some embodiments, the design of a coupled inductor for use in voltage regulation module having an MSC-POL architecture may be determined based on several factors. Some of the various factors are discussed herein.

In some embodiments, the leakage inductance may be determined based on the transient speed and current ripple, which may further depend on the application or the end-use. For example, in some applications, a leakage inductance in the range of 10 nH-50 nH per phase of CPU VRM may be appropriate.

In some embodiments, the air-gap thickness may be determined based on the desired leakage inductance and bottom core dimensions. As a non-limiting example, the thickness of the air-gap or the material constituting the air-gap may be in the range of 0.2 mm to 0.5 mm.

In some embodiments, the thickness of the leakage plate (e.g., leakage magnetic plate 3560) may be determined based on the maximum current rating and flux density saturation limit. As an example, the thickness of leakage plate may be in the range from 0.8 mm to 1.5 mm.

In some embodiments, the magnetic material for the leakage plate may be determined based on the expected operating frequency. As an example, a high frequency range of 2 MHZ˜8 MHz compared to the bottom core for delivering high-frequency flux and higher saturation limit (e.g., >0.5 T) may be appropriate for some applications.

In some embodiments, the leakage plate may be implemented as separate plates for different phases. For example, the air-gap for each of the plates may be adjusted individually to get the desired leakage inductance for each phase. This may help mitigate the asymmetric leakage inductance caused by the ladder-core structure.

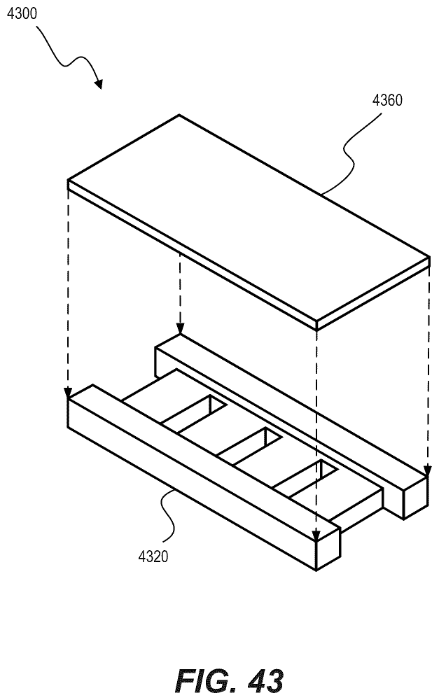

FIG. 43 illustrates a schematic of an exemplary coupled inductor, in accordance with some embodiments of the present disclosure. An exploded view of coupled inductor 4300 is illustrated in FIG. 43. Coupled inductor 4300 includes a ladder-core structure 4320 and a plate 4360 (e.g., leakage magnetic plate). Although not shown, after assembly, assembled coupled inductor 4300 may also include windings (e.g., windings 3540 of FIG. 35).

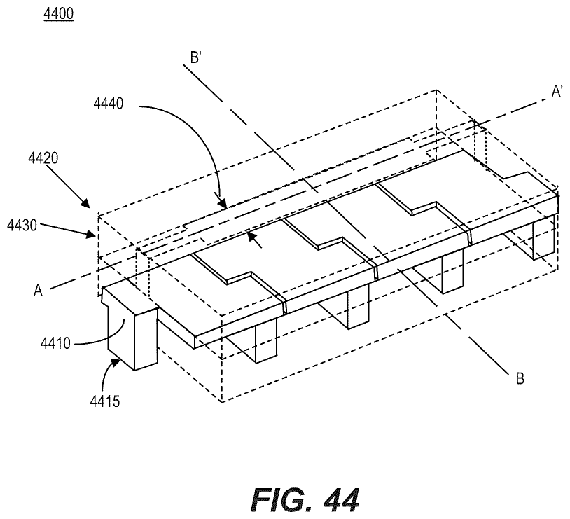

FIG. 44 illustrates an exemplary coupled inductor 4400, in accordance with some embodiments of the present disclosure. Coupled inductor 4400 may be substantially similar to and may perform substantially similar functions as coupled inductor 2800, shown in FIG. 28 and described earlier. As shown, coupled inductor 4400 provides an example of a coupled inductor including a cap layer (alternatively referred to as a cap structure) on the magnetic core. In some embodiments, coupled inductor 4400 may include magnetic core 4420 and windings 4410. As shown, windings 4410 may form posts 4415. Post 4415 may extend orthogonally from the bottom of magnetic core 4420. Magnetic core 4420 may include cap layer 4430, which may cover windings 4410. Cap layer 4430 may be made of the same material as magnetic core 4420. In some embodiments, cap layer 4430 may include a gap 4440, which may be a void or absence of material across cap layer 4430. Gap 4440 may permit tuning of coupled inductor 4400 to desired performance characteristics. For example, gap 4440 may vary in width to adjust the leakage current of coupled inductor 4400. In some embodiments, gap 4440 may be adjusted with the phases to get the desired leakage inductance for each phase.

In a preferred embodiment, although not expressly illustrated in FIG. 44, gap 4440 may be substantially symmetric along its length and width, indicated by broken lines A-A′ and B-B′, respectively. In some embodiments, gap 4440 may be asymmetric along one or both axes A-A′ or B-B′.

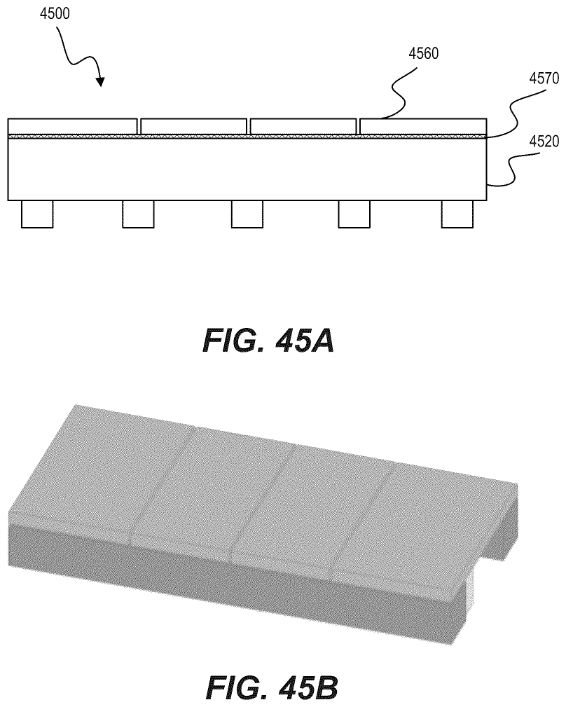

FIGS. 45A and 45B illustrate schematics of an exemplary coupled inductor 4500, in accordance with some embodiments of the present disclosure. Coupled inductor 4500 may include ladder-core structure 4520 and leakage magnetic plate 4560 separated from each other by a non-magnetic layer 4570 (also referred to as the air-gap). The non-magnetic layer 4570 may be placed adjacent to and in physical contact with the top side of ladder-core structure 4520. In some embodiments, non-magnetic layer 4570 may be of substantially similar thickness across its length, as illustrated in FIG. 45A.

In the embodiment shown in FIG. 45A, leakage magnetic plate 4560 of coupled inductor 4500 comprises four plates separated from each other by a small gap. In some embodiments, the gap between each of the plates may be substantially uniform or non-uniform. It is to be appreciated that leakage magnetic plate 4560 may include a single plate, two plates, three plates, four plates, or a rectangular array of plates, or any number of plates, as appropriate. In some embodiments, the length and width of leakage magnetic plate 4560 may be substantially similar to the length and width of the underlying ladder-core structure 4520 such that it covers the ladder-core structure 4520 in its entirety.

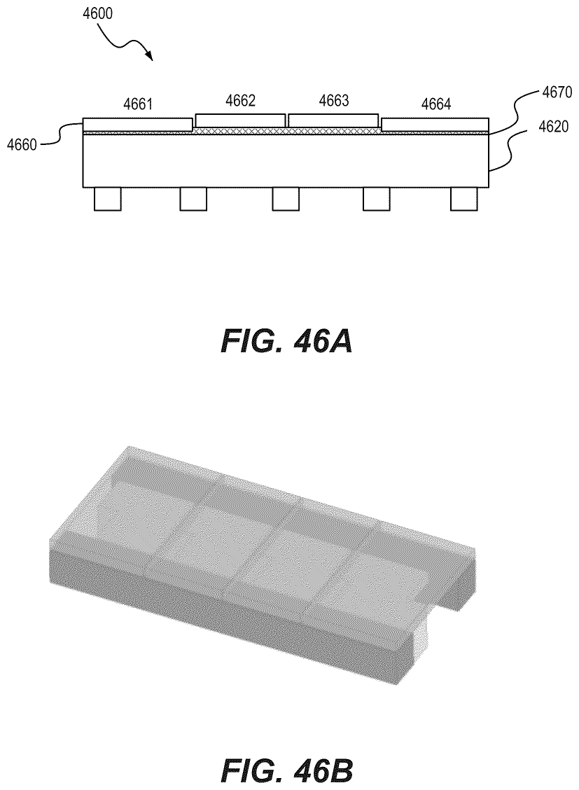

FIGS. 46A and 46B illustrate schematics of an exemplary coupled inductor 4600, in accordance with some embodiments of the present disclosure. Coupled inductor 4600 may include ladder-core structure 4620 and leakage magnetic plate 4660 separated from each other by a non-magnetic layer 4670 (also referred to as the air-gap). The non-magnetic layer 4670 may be placed adjacent to and in physical contact with the top side of ladder-core structure 4620. In some embodiments, the thickness of non-magnetic layer 4670 may vary across its length, as illustrated in FIG. 46A. The thickness may be varied based on the phases to obtain the desired leakage inductance for each phase. As illustrated in FIG. 46A, non-magnetic layer 4670 may be thicker underneath the center two plates 4662 and 4663 of leakage magnetic plate 4660 in comparison with the two edge plates 4661 and 4664, to provide a variable air-gap. In other words, the air gap thickness is larger in the center than the edges of coupled inductor 4600. Although not illustrated, it is to be appreciated that the air gap thickness may be adjusted using other means. For example, alternatively or additionally, the thickness of each of the leakage magnetic plates may be varied along its length, or the height of ladder-core structure 4620 may be adjusted or varied across its length, or other arrangements of leakage magnetic plates and ladder-core structures to adjust the air gap thickness are possible as well.

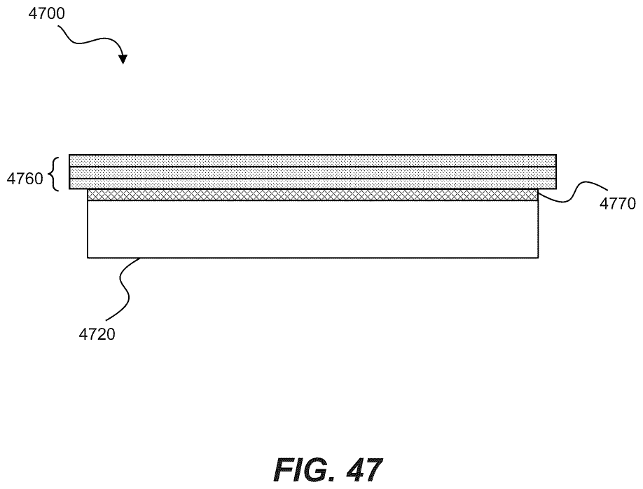

FIG. 47 illustrates a schematic of an exemplary coupled inductor 4700, accordance with some embodiments of the present disclosure. Coupled inductor 4700 may include ladder-core 4720, a non-magnetic layer 4770, and leakage magnetic layer 4760. In the embodiment shown in FIG. 47, though leakage magnetic layer 4760 of coupled inductor 4700 is shown as comprising three separate magnetic sheets, leakage magnetic layer 4760 may comprise one or more magnetic sheets.

In some embodiments, one or more magnetic sheets may constrain the leakage flux by providing a low-reluctance leakage path. This may allow an increase in the leakage inductance and may decrease the current ripple in a similar manner as using a magnetic plate (e.g., leakage magnetic plate 3560, 3660, 4360, 4560, 4660). The resulting smaller root-mean-square (RMS) and peak current values may enable a reduction in the conduction losses, switching losses, and parasitic inductance losses, thereby improving the converter efficiency.

In some embodiments, one or more magnetic sheets may have a thickness ranging from 100 μm to 500 μm. In some embodiments, a magnetic sheet may be 130 μm thick. In some embodiments, higher number of sheets may provide a higher leakage inductance, which may result in lower current ripple. In circuits, lower current ripple may result in lower power losses, and thereby higher efficiency. In addition, a higher number of sheets may increase the overall thickness of leakage magnetic layer, which may reduce the magnetic losses. In some embodiments, using one or more magnetic sheets may help shield the high-frequency electromagnetic interference (EMI) noise radiated from the converter in electronic equipments.

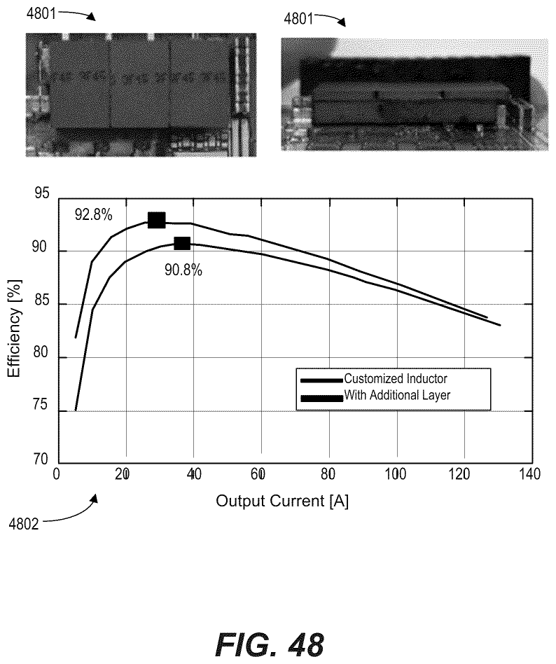

FIG. 48 illustrates an exemplary inductor 4801 and efficiency graph 4802, in accordance with some embodiments of the present disclosure. For example, inductor 4801 may include an additional magnetic layer for reduced current ripple, thereby improving peak efficiency (e.g., by 2%) while the full load efficiency remains unchanged.

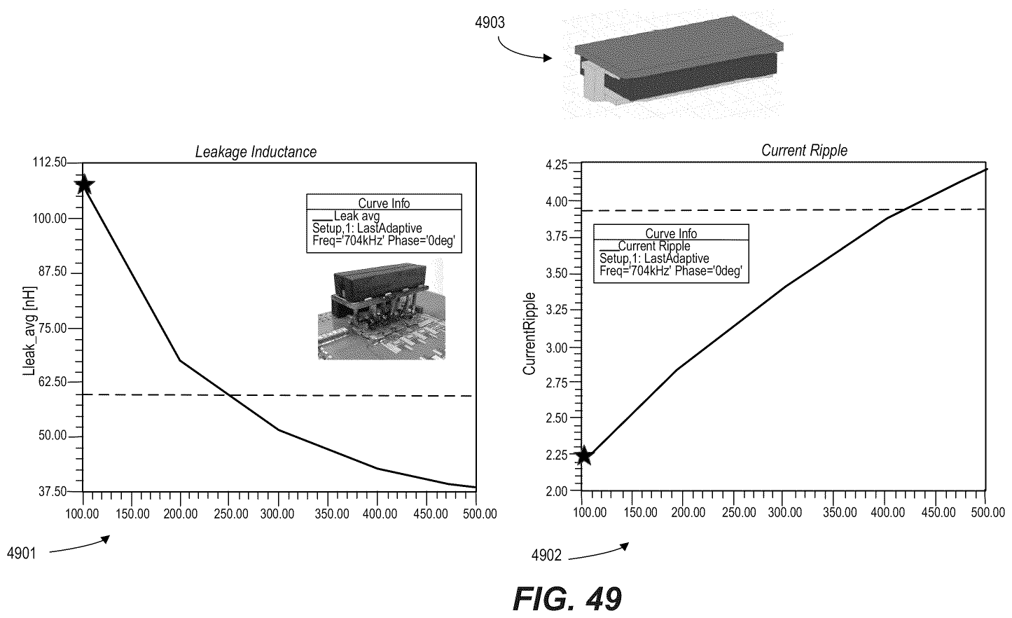

FIG. 49 illustrates an exemplary leakage inductance graph 4901 and an exemplary current ripple graph 4902, in accordance with some embodiments of the present disclosure. For example, an inductor 4903 with an additional layer at a sweep air gap distance at around 700 kHz (e.g., 704 kHz) may exhibit trends shown in graph 4901 and graph 4902.

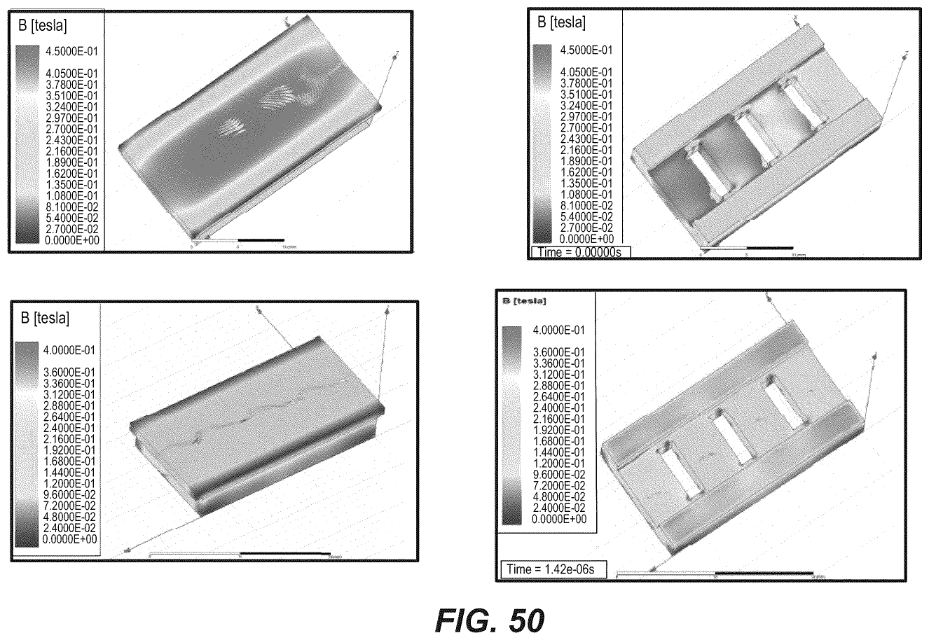

FIG. 50 illustrates exemplary inductors and the flux saturation at heavy loads of the inductors, in accordance with some embodiments of the present disclosure. FIG. 50 shows that inductors with an additional layer and a small air gap distance (e.g., 0.10 mm, 0.25 mm at ˜700 kHz and 120 A) demonstrate low leakage reluctance, saturation at heavy loads, and unchanged efficiency at heavy loads.

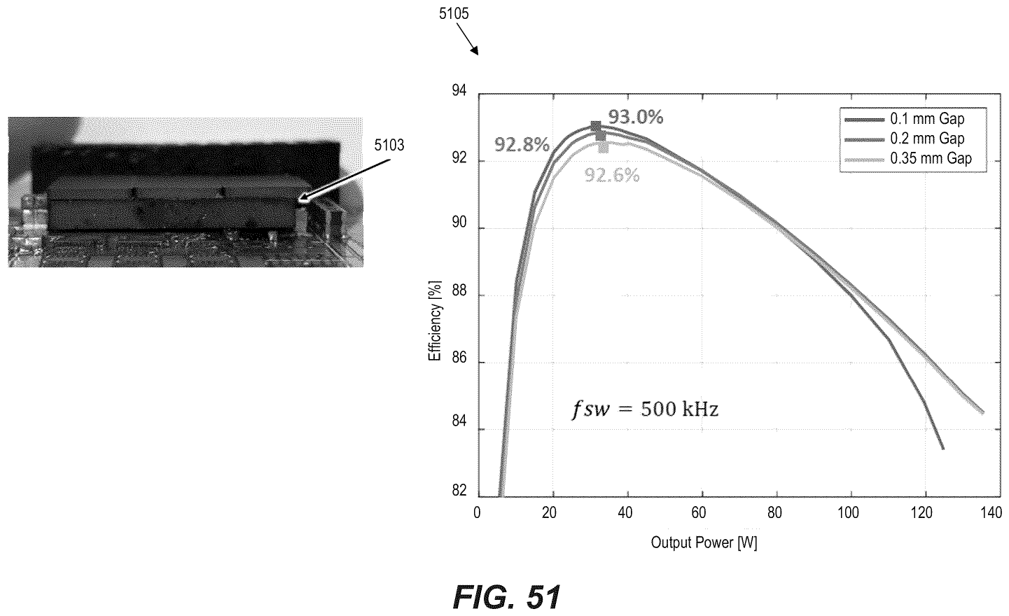

FIG. 51 illustrates an exemplary graph 5105 of the impact of the thickness of an air gap 5103 of an inductor 5101 on efficiency, in accordance with some embodiments of the present disclosure. For example, air gap 5103 may have a thickness of 0.10 mm, 0.20 mm, 0.35 mm, etc. As shown in graph 5105, reducing the thickness of air gap 5103 may increase peak efficiency. In some embodiments, reducing the thickness of air gap 5103 may cause saturation at a heavy load.

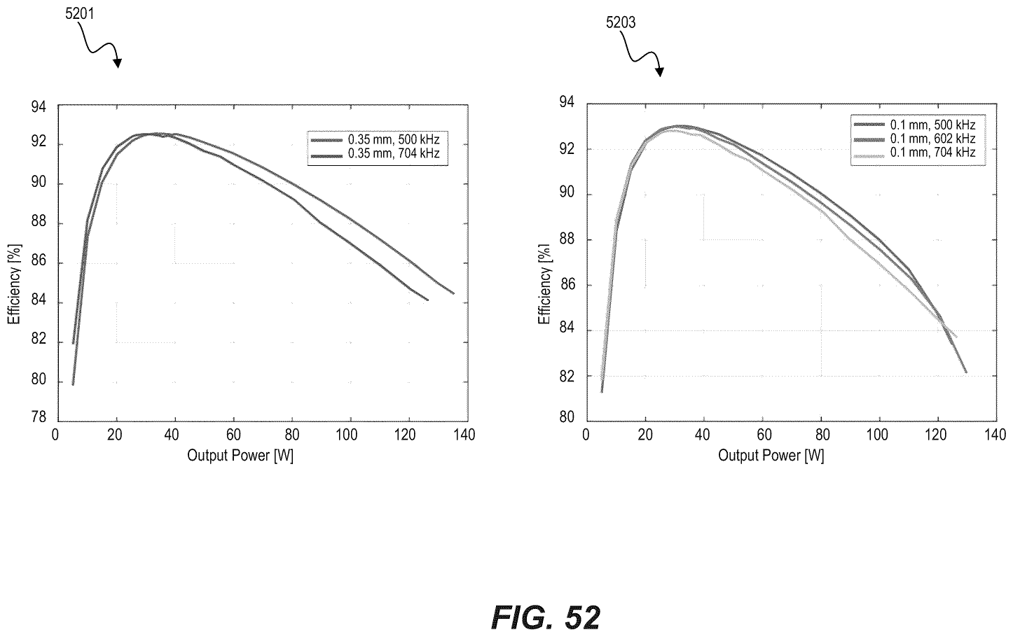

FIG. 52 illustrates exemplary graphs 5201 and 5203 of the impact of the switching capacity on efficiency, in accordance with some embodiments of the present disclosure. For example, graphs 5201 and 5203 show that reducing frequency may improve the power rating and heavy load efficiency if the air gap thickness of an inductor is certain thicknesses (e.g., 0.10 mm, 0.35 mm, etc.; not saturated at heavy load).

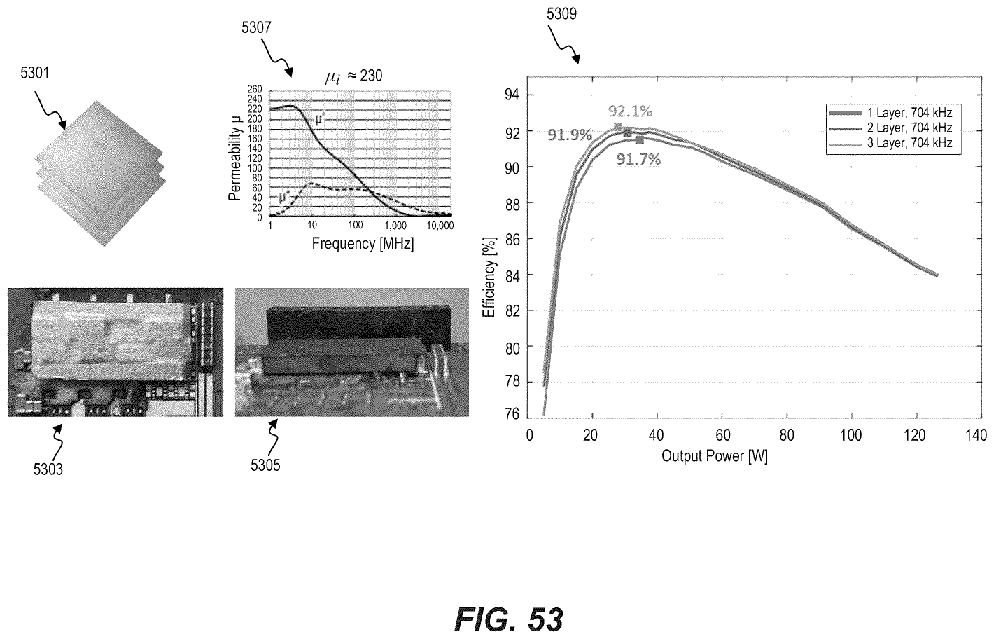

FIG. 53 illustrates exemplary views of an inductor with one or more magnetic sheets and an exemplary graph 5309 showing the effect of the number of magnetic sheets on efficiency, in accordance with some embodiments of the present disclosure. View 5301 shows a plurality of magnetic sheets (e.g., 0.13 mm thickness per layer) of an inductor, view 5303 shows a top view of the inductor, view 5305 shows a side view of the inductor, and plot 5307 shows relationships between permeability and frequency of the magnetic sheets. Graph 5309 shows a relationship between device efficiency and output power for different numbers of magnetic sheets in an inductor.

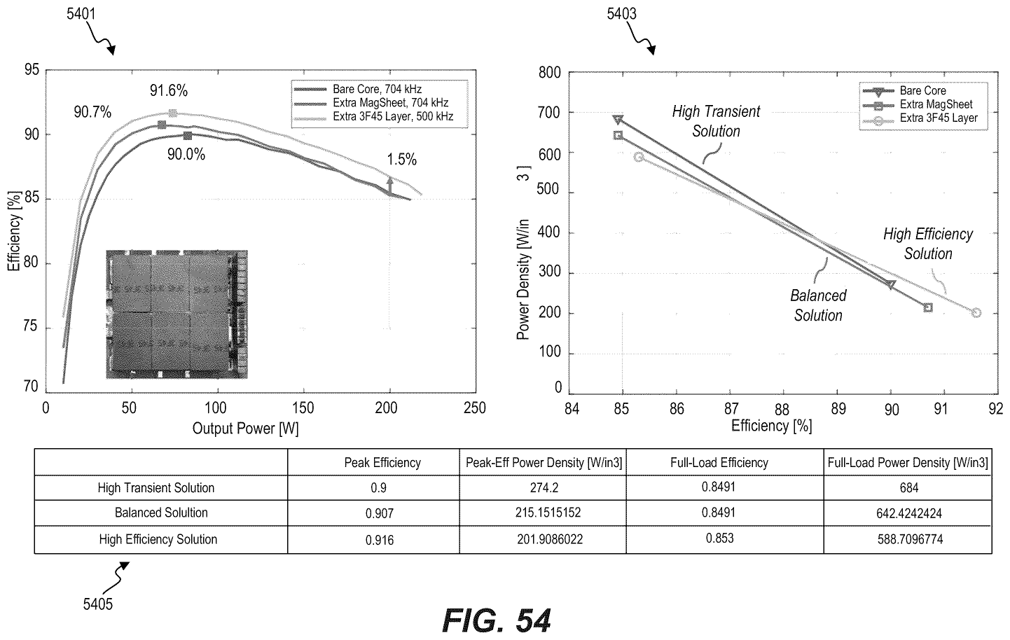

FIG. 54 illustrates exemplary graphs 5401 and 5403 and table 5405, in accordance with some embodiments of the present disclosure. Graph 5401 shows a relationship between switched capacitor efficiency and output power for different numbers of magnetic sheets in an inductor. Graph 5403 shows a relationship between power density and switched capacitor efficiency for different numbers of magnetic sheets in an inductor. Table 5405 shows data points of graphs 5401 and 5403 in tabular form.

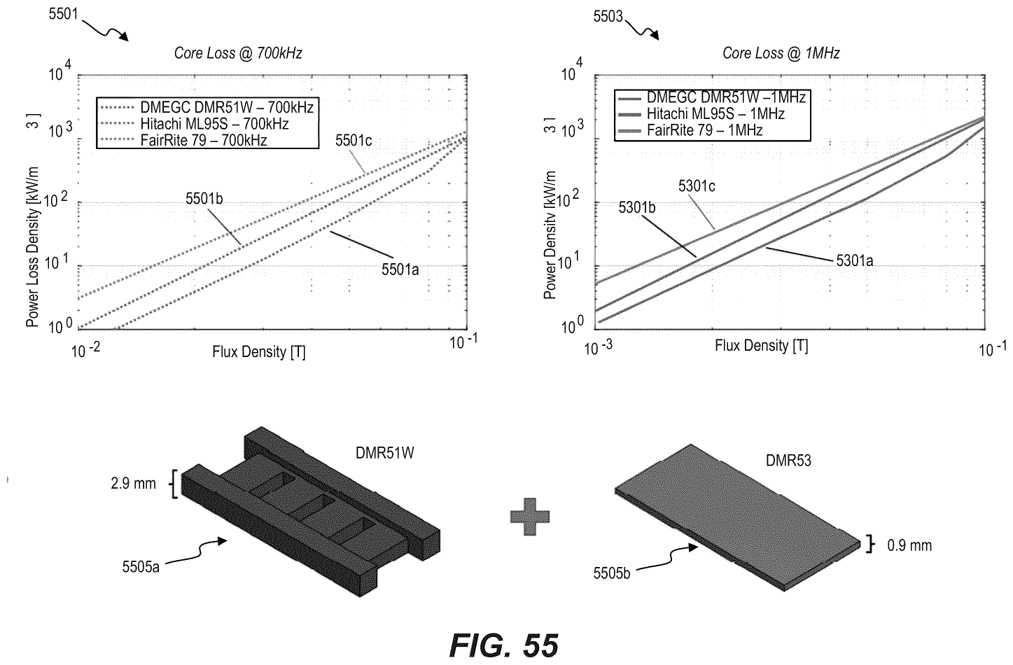

FIG. 55 illustrates exemplary graphs 5501 and 5503 and inductor core 5505, in accordance with some embodiments of the present disclosure. Graph 5501 shows a relationship between power loss density and flux density for different inductor cores, including inductor core 5505, with a core loss at 700 hKz. Curve 5501a corresponds to inductor core 5505, curve 5501b corresponds to the Hitachi ML95S inductor core, and curve 5501c corresponds to the FairRite 79 inductor core. Graph 5503 shows a relationship between power loss density and flux density for different inductor cores, including inductor core 5505, with a core loss at 1 MHz. Curve 5301a corresponds to inductor core 5505, curve 5301b corresponds to the Hitachi ML95S inductor core, and curve 5301c corresponds to the FairRite 79 inductor core. Inductor core 5505 may include ladder structure 5505a with a thickness of 2.9 mm and sheet 5505b with a thickness of 0.9 mm.

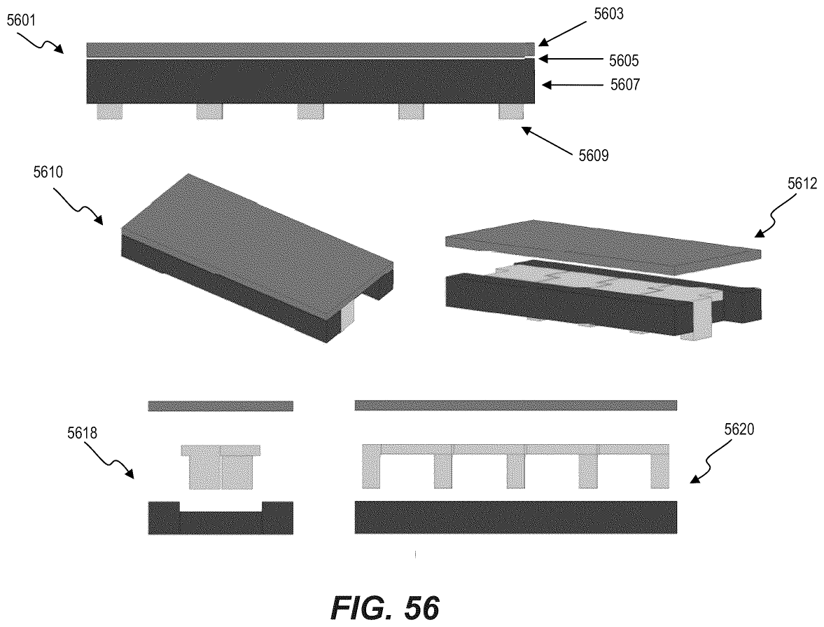

FIG. 56 illustrates a schematic of an exemplary inductor 5601, in accordance with some embodiments of the present disclosure. Inductor 5601 may include a first magnetic material 5603, an air gap 5605, a second magnetic material 5607, and winding 5609. FIG. 56 shows views 5610, 5612, 5614, 5616, 5618, and 5620 of inductor 5601.

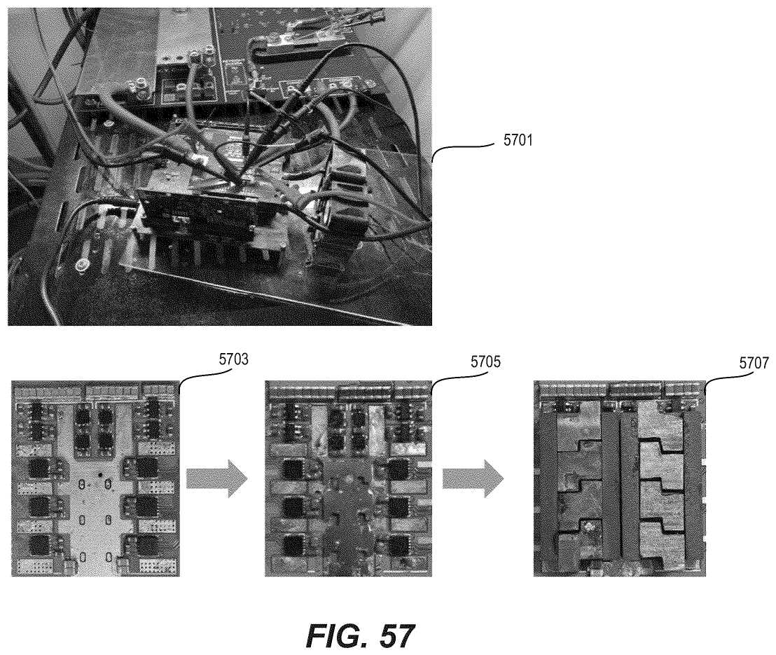

FIG. 57 illustrates a schematic of an exemplary inductor, in accordance with some embodiments of the present disclosure. FIG. 57 shows hardware 5701 of an inductor under test, bare pad 5703 of the inductor, backbone copper 5705 of the inductor, and full assembly 5707 of the inductor.

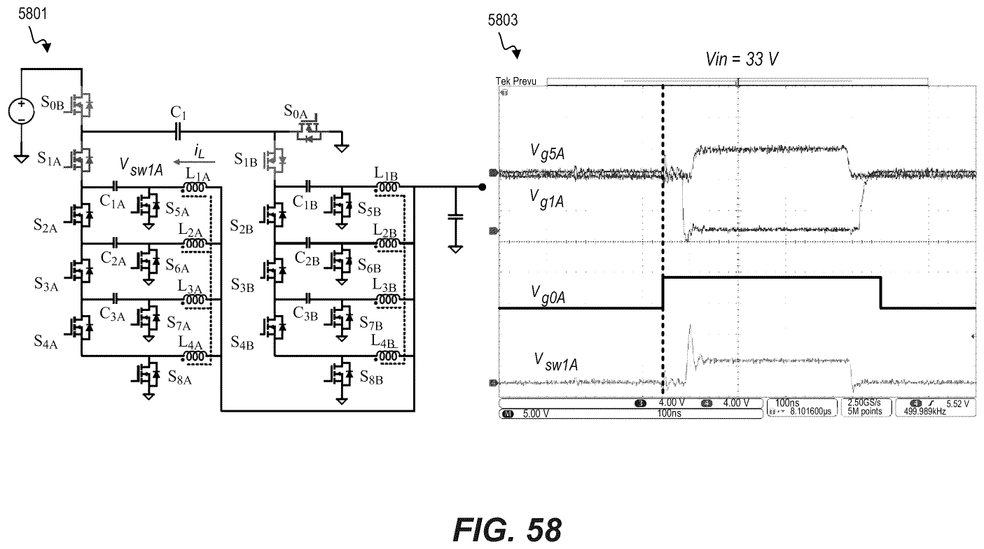

FIG. 58 illustrates an exemplary circuit diagram 5801 of an inductor and graph 5803, in accordance with some embodiments of the present disclosure. Graph 5803 shows switch node voltage signals.

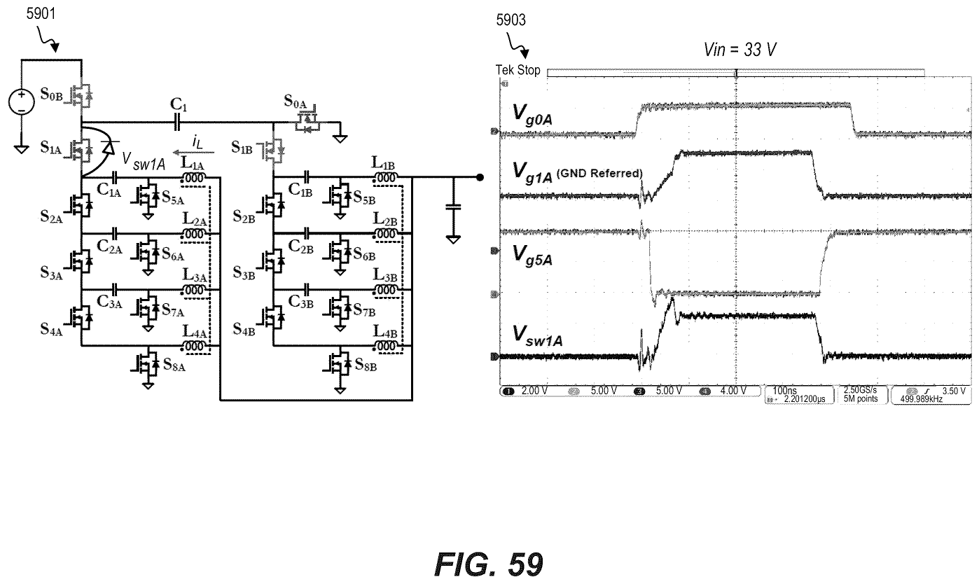

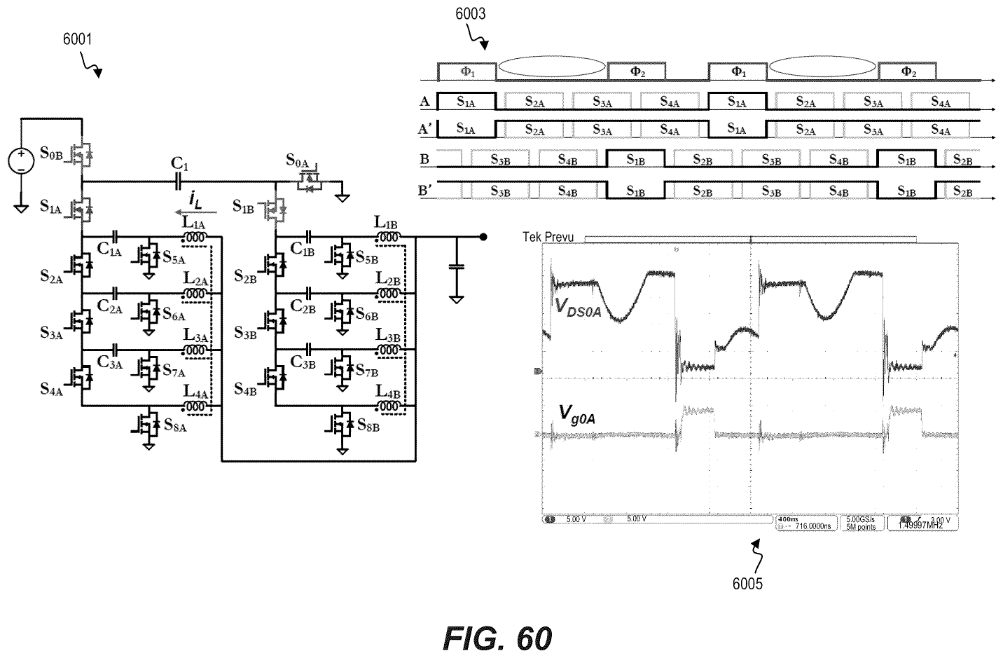

FIG. 59 illustrates an exemplary circuit diagram 5901 of an inductor and graph 5903, in accordance with some embodiments of the present disclosure. Graph 5903 shows switch node voltage signals.

FIG. 60 illustrates an exemplary circuit diagram 6001 of an inductor and graphs 6003 and 6005, in accordance with some embodiments of the present disclosure. Graph 6003 shows off time resonance signals of an inductor and graph 6005 shows voltage signals of an inductor.

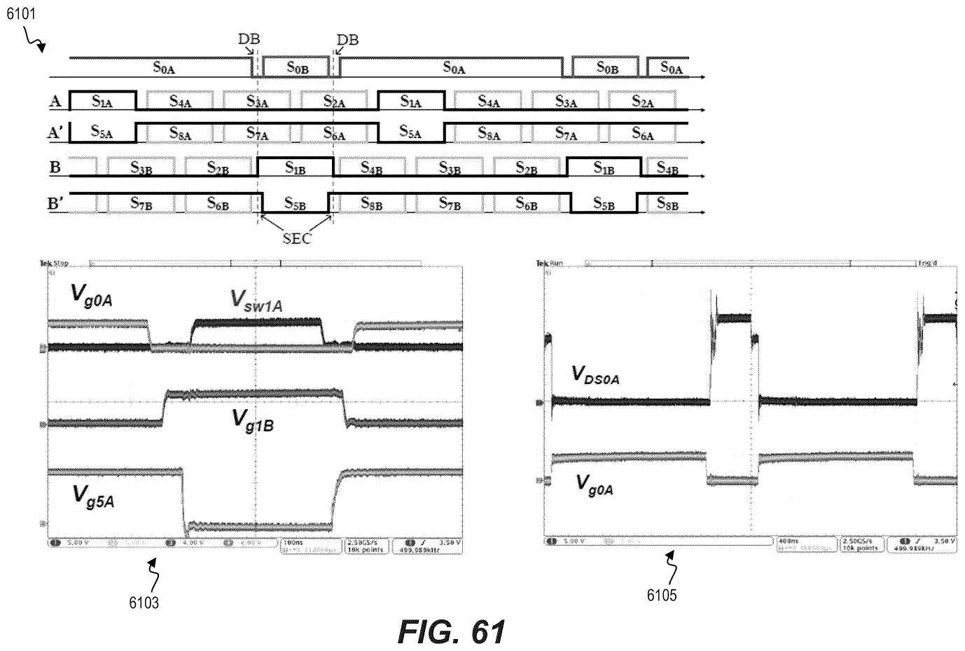

FIG. 61 illustrates exemplary graphs 6101, 6103, and 6105, in accordance with some embodiments of the present disclosure. Graph 6101 shows revised timing signals of an inductor and graphs 6103 and 6105 show voltage signals of an inductor.

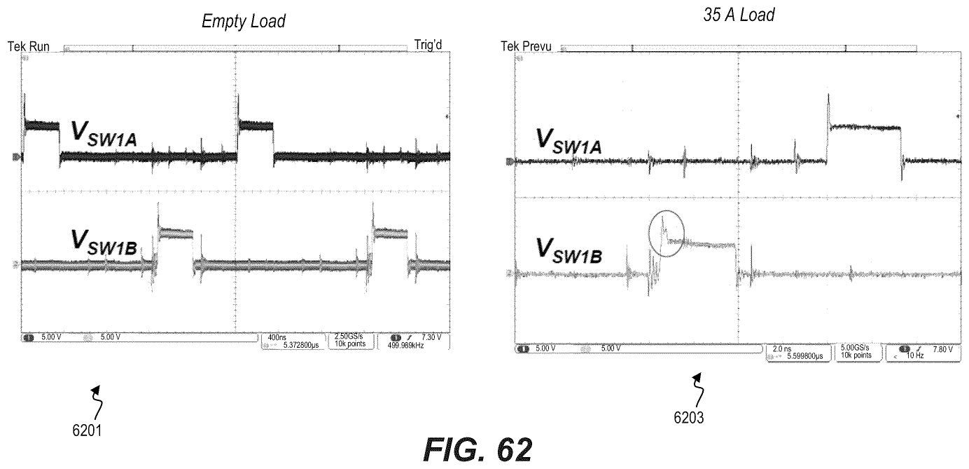

FIG. 62 illustrates exemplary graphs 6201 and 6203 with measured waveforms, in accordance with some embodiments of the present disclosure. Graph 6201 shows voltage signals of an inductor at an empty load and graph 6203 shows voltage signals of an inductor at a 35 A load.

Disclosed embodiments may include switched-capacitor power converters. Switched-capacitors may also be referred to as cascade multipliers, switching capacitors, switched capacitors, switch capacitors, charge pumps, and voltage multipliers. The advantages and benefits of switched-capacitor power converters may enable them to be used in a wide array of applications. For example, applications of switched power converters include portable device, mobile computing, and/or communication products and components (e.g., notebook computers, ultra-book computers, tablet devices, and cell phones), displays (e.g., LCDs, LEDs), radio-based devices and systems (e.g., cellular systems, WiFi, Bluetooth, Zigbee, Z-Wave, and GPS-based devices), wired network devices and systems, data centers (e.g., for battery-backup systems and/or power conversion for processing systems and/or electronic/optical networking systems), internet-of-things (IoT) devices (e.g., smart switches and lights, safety sensors, and security cameras), household appliances and electronics (e.g., set-top boxes, battery-operated vacuum cleaners, appliances with built-in radio transceivers such as washers, dryers, and refrigerators), AC/DC power converters, use in electric vehicles of all types (e.g., for drive trains, control systems, and/or infotainment systems), and other devices and systems that utilize portable electricity generating sources and/or require power conversion.

Disclosed embodiments may include switched-capacitor power converters that utilize specific types of capacitors, particularly for the fly capacitors. For example, it may be useful for fly capacitors to have low equivalent series resistance (ESR), low DC bias degradation, high capacitance, and/or small volume. Low ESR may be of particular importance for switched-capacitor power converters that incorporate additional switches and fly capacitors to increase the number of voltage levels. Disclosed embodiments may include a particular capacitor based on a consideration of specifications for power level, efficiency, size, etc. Various types of capacitor technologies may be used, including ceramic (including multi-layer ceramic capacitors (MLCC)), electrolytic capacitors, film capacitors (including power film capacitors), and IC-based capacitors. Capacitor dielectrics may vary as needed for particular applications, and may include dielectrics that are paraelectric, such as silicon dioxide (SiO2), hafnium dioxide (HFO2), or aluminum oxide Al₂O₃. In addition, switched-capacitor power converter designs may beneficially utilize intrinsic parasitic capacitances (e.g., intrinsic to the power FETs) in conjunction with or in lieu of designed capacitors to reduce circuit size and/or increase circuit performance. Disclosed embodiments may also select capacitors for switched capacitor converters based on capacitor component variations, reduced effective capacitance with DC bias, and ceramic capacitor temperature coefficients (e.g., minimum and maximum temperature operating limits, and capacitance variation with temperature).

Similarly, in various embodiments of switched-capacitor power converters, it may be beneficial to use specific types of inductors. For example, disclosed embodiments may include inductors that have low DC equivalent resistance, high inductance, and small volume to increase performance.

Disclosed embodiments may include one or more controllers to control, for example, the startup and operation of disclosed embodiments. Controller(s) may be implemented as a microprocessor, a microcontroller, a digital signal processor (DSP), register-transfer level (RTL) circuitry, and/or combinatorial logic.

Disclosed embodiments may include one or more MOSFETs. In embodiments, a MOSFET may refer to any field effect transistor (FET) having an insulated gate whose voltage determines the conductivity of the transistor. In some embodiments, MOSFETS may encompass insulated gates having a metal or metal-like, insulator, and/or semiconductor structure. The metal or metal-like structures may include at least one electrically conductive material (such as aluminum, copper, or other metal, or highly doped polysilicon, graphene, or other electrical conductors). The insulator structures may include at least one insulating material (such as silicon oxide or other dielectric material). The semiconductor structures may include at least one semiconductor material.

Disclosed embodiments can meet a wide variety of specifications and may be implemented in any suitable integrated circuit (IC) technology (including but not limited to MOSFET structures), or in hybrid or discrete circuit forms. Integrated circuit embodiments may be fabricated using any suitable substrates and processes, including but not limited to standard bulk silicon, high-resistivity bulk CMOS, silicon-on-insulator (SOI), and silicon-on-sapphire (SOS). Unless otherwise noted above, embodiments of the invention may be implemented in other transistor technologies such as bipolar, BiCMOS, LDMOS, BCD, GaAs HBT, GaN HEMT, GaAs pHEMT, and MESFET technologies. Fabrication in CMOS using SOI or SOS processes may enable circuits with low power consumption, the ability to withstand high power signals during operation due to FET stacking, good linearity, and high frequency operation (e.g., radio frequencies up to and exceeding 300 GHZ). Monolithic IC implementation may be useful since parasitic capacitances generally can be kept low (or at a minimum, kept uniform across all units, permitting them to be compensated) by careful design.

Voltage levels may be adjusted, and/or voltage and/or logic signal polarities reversed, depending on a particular specification and/or implementing technology (e.g., NMOS, PMOS, or CMOS, and enhancement mode or depletion mode transistor devices). Disclosed embodiments may adjust component voltage, current, and power handling capabilities as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functionality without significantly altering the functionality of the disclosed circuits.

Circuits and devices in accordance with the present disclosure may be used alone or in combination with other components, circuits, and devices. Embodiments may be fabricated as integrated circuits (ICs), which may be encased in IC packages and/or in modules for case of handling, manufacture, and/or improved performance. For example, IC embodiments of the present disclosure may be used in modules in which one or more of such ICs are combined with other circuit components or blocks (e.g., filters, amplifiers, passive components, and possibly additional ICs) into one package. The ICs and/or modules may be then combined with other components, such as on a printed circuit board, to form part of an end product such as a cellular telephone, laptop computer, or electronic tablet, or to form a higher-level module which may be used in a wide variety of products, such as vehicles, test equipment, medical devices, etc. Through various configurations of modules and assemblies, such ICs may enable a mode of communication, such as wireless communication.

Embodiments may include implementations in hardware or software, or a combination of both (e.g., programmable logic arrays). In some embodiments, various general purpose computing machines may be used with programs written in accordance with the teachings herein. In other embodiments, a special purpose computer or special-purpose hardware (such as integrated circuits) may be used to perform particular functions. Embodiments may be implemented in one or more computer programs (i.e., a set of instructions or codes) executing on one or more programmed or programmable computer systems (which may be of various architectures, such as distributed, client/server, or grid) each including, for example, at least one processor, at least one data storage system (which may include volatile and non-volatile memory and/or storage elements), at least one input device or port, and/or at least one output device or port. Program instructions or code may be applied to input data to perform the functions described herein and generate output information. The output information may be applied to one or more output devices.

Disclosed embodiments may involve computer programs implemented in a computer language (e.g., machine, assembly, or high-level procedural, logical, object-oriented programming languages or a custom language/script) to communicate with a computer system and may be implemented in a distributed manner in which different parts of the computation specified by the software are performed by different processors. The computer language may be a compiled or interpreted language. Computer programs implementing certain embodiments may form one or more modules of a larger program or system of programs. Some or all of the elements of the computer program may be implemented as data structures stored in a computer readable medium or other organized data conforming to a data model stored in a data repository.

Disclosed embodiments may include computer program(s) that may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently, or permanently), the storage media or device being readable by a general or special purpose programmable computer for configuring and operating the computer when the storage media or device is read by the computer system to perform the procedures described above. Disclosed embodiments may also be implemented as a non-transitory computer-readable storage medium, configured with a computer program, where the storage medium so configured causes a computer system to operate in a specific or predefined manner to perform the functions described above.

In the specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is also intended that the sequence of steps shown in figures is only for illustrative purposes and is not intended to be limited to any particular sequence of steps. As such, those skilled in the art can appreciate that these steps can be performed in a different order while implementing the same method.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not to be considered essential features of those embodiments unless the embodiment is inoperative without those elements.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. The embodiments may further be described using the following clauses:

1. A power converter circuit comprising:
at least one charge distributor that include switches, capacitors, and inductors, wherein:
   the at least one charge distributor has a fixed voltage conversion ratio; the switches in the at least one charge distributor operate at a common frequency; and
   each of the at least one charge distributor has four terminals with one terminal connected to a high voltage, one terminal connected to ground, and two branch terminals having a voltage between the high voltage and ground;
a plurality of voltage regulators that include switches, inductors, and capacitors, wherein the voltage regulators regulates voltage by changing a duty ratio of the switches,
wherein the terminals connected to the high voltage of the at least one charge distributor are connected to a high voltage terminal of a system, and the low voltage side of the voltage regulators are connected to a low voltage terminal of the system.
   2. The power converter circuit of clause 1 wherein:
the switches of the voltage regulators are operating at a frequency higher or equal to the switches of the at least one charge distributor.
   3. The power converter circuit of any one of clauses 1-2 wherein:
at all times during operation of the power converter circuit, at least one capacitor is connected between the high voltage terminal, the ground, and the branch terminals, functioning as a capacitive divider, and dividing the high voltage into smaller intermediate voltage domains;
a charge distributor of the at least one charge distributor includes a plural of modular circuits operated in interleaving fashion.
   4. The power converter circuit of clause 3 comprising:
a first resulting voltage of the at least one capacitor corresponding to a switch coupled to the high voltage terminal and a first branch terminal; and
a second resulting voltage of the at least one capacitor corresponding to a switch coupled to the one terminal connected to ground and a second branch terminal,
wherein the first resulting voltage is equal to the second resulting voltage.
   5. The power converter circuit of clause 3 wherein:
a first resulting current of the at least one capacitor corresponding to a switch coupled to the high voltage terminal and a first branch terminal; and
a second resulting current of the at least one capacitor corresponding to a switch coupled to the one terminal connected to ground and a second branch terminal,
wherein the first resulting current is equal to the second resulting current.
   6. The power converter circuit of any one of clauses 1-5 wherein:
during operation of the power converter circuit, at least one charge storage block is connected between the high voltage terminal, the ground, and the branch terminals, functioning as a capacitive divider, and dividing the high voltage into smaller intermediate voltage domains.
   7. The power converter circuit of clause 6 wherein:
the at least one charge storage block stores one or more capacitors.
   8. The power converter circuit of clause 6 wherein:
the at least one charge storage block stores one or more inductors.
   9. The power converter circuit of any one of clauses 1-8 wherein:
a voltage regulator of the plurality of voltage regulators has a plurality of terminals with a terminal connected to ground, one terminal connected to a low voltage, and one branch terminal of a charge distributor of the at least one charge distributor.
   10. The power converter circuit of clause 9 wherein:
an inductor of the voltage regulator is positioned between the low voltage and the one branch terminal.
   11. The power converter circuit of clause 10 wherein:
the switches comprise a switch between the one branch terminal and the inductor of the voltage regulator.
   12. The power converter circuit of any one of clauses 10-11 wherein:
the switches comprise a switch between ground and a node between the one branch terminal and the inductor of the voltage regulator.
   13. The power converter circuit of any one of clauses 9-12 wherein:
a capacitor of the voltage regulator is positioned between the low voltage and ground.
   14. The power converter circuit of any one of clauses 9-12 wherein:
a capacitor of the voltage regulator is positioned between an inductor of the voltage regulator and the one branch terminal.
   15. The power converter of any one of clauses 1-14 wherein:
a charge distributor of the at least one charge distributor comprises:
   a first inductor positioned between the high voltage and the low voltage, and
   a second inductor positioned between the low voltage and ground.
      16. The power converter of any one of clauses 1-15 wherein:
a charge distributor of the at least one charge distributor comprises:
   an inductor positioned between a first branch terminal of the two branch terminals and the low voltage.
      17. The power converter circuit of any one of clauses 1-16 wherein:
a charge distributor of the at least one charge distributor comprises: a capacitor positioned between the low voltage and ground.
   18. The power converter circuit of any one of clauses 1-17 wherein:
a charge distributor of the at least one charge distributor comprises:
   a capacitor positioned between the one terminal connected to the high voltage and the one terminal connected to ground.
      19. The power converter of any one of clauses 1-18 wherein:
the inductors of a charge distributor of the at least one charge distributor comprise subsets of inductors, each subset of inductors comprising a shared magnetic core.
   20. The power converter of clause 19 wherein:
a number of the subsets of inductors is equal to a number of series-capacitor buck units.
   21. The power converter of clause 1 wherein:
the inductors of a charge distributor of the at least one charge distributor share a magnetic core.
   22. The power converter of any one of clauses 1-21 wherein:
two charge distributors of the at least one charge distributor are connected in parallel.
   23. The power converter of clause 22 wherein:
the inductors of the two charge distributors are coupled to each other.
   24. The power converter circuit of any one of clauses 22-23 wherein:
switches of the two charge distributors comprise gate driver control signals.
   25. The power converter circuit of any one of clauses 22-23 further comprising: level shifters to transform signal voltage levels for switches of the two charge distributors with floating sources.
   26. The power converter of any one of clauses 1-25 wherein:
the at least one charge distributor comprise a first charge distributor that drive a second charge distributor and a third charge distributor; and
the second charge distributor and the third charge distributor each drive two series-capacitor buck voltage regulators.
   27. The power converter circuit of any one of clauses 1-26 wherein:
the inductors in the voltage regulators operate as DC inductors with DC average current value and minimal peak-to-peak ripple; and
the voltage regulator includes a plural of modular units operated in interleaving.
   28. The power converter circuit of any one of clauses 1-27 wherein:
there are no intermediate bus capacitors between the charge distributors and voltage regulators.
   29. The power converter circuit of any one of clauses 1-28 wherein: there are more voltage regulator circuits than charge distributors.
   30. The power converter circuit of any one of clauses 1-29 wherein: each charge distributor includes two switches and one capacitor.

31. The power converter circuit of any one of clauses 1-30 wherein:
the capacitors in the charge distributor are charged/discharged by the inductors in the voltage regulators; and
during the charging/discharging process, the capacitor voltages of the charge distributor interact with the inductor currents of the voltage regulators to achieve auto balancing of both capacitor voltages and inductor currents.
   32. The power converter circuit of any one of clauses 1-31 wherein:
the inductors in the charge distributors operate as resonant inductors and resonate with capacitors in the charge distributors; and
current charging and discharging the capacitor is sinusoidal or partially sinusoidal.
   33. The charge distributors circuit of any one of clauses 30-32 wherein:
the charge distributors are resonant switched capacitor converters with a plural of switches connected in series, and a plural of capacitors reconfigured by the plural of series-connected switches to transfer the energy.
   34. The charge distributors circuit of any one of clauses 31-33 wherein:
the charge distributors are resonant switched capacitor converters with an inductor connected in series with flying capacitors.
   35. The charge distributors circuit of any one of clauses 31-34 wherein:
the charge distributors are resonant switched capacitor converters with an inductor connected at the low voltage terminal of a flying capacitor multilevel converter.
   36. The charge distributors circuit of any one of clauses 31-35 wherein:
the charge distributors are resonant switched capacitor converters comprising a plural of resonant inductor and capacitor network;
the resonant switched capacitor converters are reconfigured by the switches to transfer the energy.
   37. A voltage regulator circuit of any one of clauses 1-36 wherein: the voltage regulators are multiphase buck converters.
   38. A voltage regulator circuit of any one of clauses 1-36 wherein: the voltage regulators are series buck converters.
   39. A voltage regulator circuit of any one of clauses 1-36 wherein: the voltage regulators are hybrid switched capacitor converters.
   40. A voltage regulator circuit of any one of clauses 1-36 wherein: the inductors of the voltage regulator are multiphase coupled inductors.
   41. The power converter circuit of any one of clauses 1-40 wherein:
the power converter circuit is used to power computer microprocessors.
   42. The power converter circuit of any one of clauses 1-41 wherein:
the voltage of the high voltage terminal of the voltage divider is between 40 V-60 V.
   43. The power converter circuit of any one of clauses 1-42 wherein:
the voltage of the low voltage terminal of the voltage divider is between 20 V-30 V.
   44. The power converter circuit of any one of clauses 1-43 wherein:
the voltage of the low voltage terminal of the voltage regulator is between 0.5 V-3 V.
   45. The power converter circuit of any one of clauses 1-44, further comprising a gate driver circuit.
   46. A coupled inductor, comprising:
a magnetic core having a first void that forms two lengths of magnetic core material between two ends; and
electrically conductive windings that wrap the two lengths of magnetic core material.
   47. The coupled inductor of clause 46, wherein the two lengths of magnetic core material form of a ladder structure.
   48. The coupled inductor of clause 47, wherein the two lengths of magnetic core material form rungs of the ladder structure.
   49. The coupled inductor of any one of clauses 47-48, wherein the electrically conductive windings wrap around a circumference of each rung of the ladder structure.
   50. The coupled inductor of any one of clauses 47-49, wherein the ladder structure is to minimize hot spots in the coupled inductor.
   51. The coupled inductor of any one of clauses 47-50, wherein the magnetic core comprises a plurality of layers.
   52. The coupled inductor of clause 51, wherein the plurality of layers have different thicknesses.
   53. A power converter for receiving the coupled inductor of any one of clauses 46-52, the coupled inductor including windings having a post design and the power converter comprising:
a printed circuit board (PCB); and
a plurality of capacitors attached to the PCB.
   54. The coupled inductor of any one of clauses 46-53, wherein the magnetic core includes two layers made of different materials.
   55. The coupled inductor of clause 54, wherein:
a first layer of the magnetic core comprises a first permeability and a first saturation capability,
the second layer of the magnetic core comprises a second permeability and a second saturation capability, and
the first permeability is greater than the second permeability and the first saturation capability is less than the second saturation capability.
   56. The coupled inductor of any one of clauses 46-55, wherein the magnetic core includes a cap layer.
   57. The coupled inductor of clause 56, wherein the cap layer of the magnetic core includes a gap.
   58. The coupled inductor of any one of clauses 46-57, wherein the windings form a tessellating pattern.
   59. The coupled inductor of any one of clauses 46-58, wherein the windings include posts that extend away from a given face of the magnetic core in a common direction.
   60. A coupled inductor, comprising:
a magnetic core having a plurality of first voids arranged in a first direction and at least one second void arranged in a second direction perpendicular to the first direction,
the plurality of first voids forming a plurality of lengths of magnetic core material between two ends in the first direction; and
electrically conductive windings that wrap the plurality lengths of magnetic core material.
   61. The coupled inductor of clause 60, wherein the magnetic core includes two layers made of different materials.
   62. A power converter for receiving the coupled inductor of any one of clauses 60-61, the coupled inductor including windings having a post design and the power converter comprising:
a printed circuit board (PCB); and
a plurality of capacitors attached to the PCB.
   63. A power converter circuit comprising:
a charge distributor that includes switches, capacitors, and inductors, wherein: the charge distributor has a fixed voltage conversion ratio;
   the switches in the charge distributor operate at a common frequency; and
   the charge distributor has four terminals with one terminal connected to a high voltage, one terminal connected to ground, and two branch terminals having a voltage between the high voltage and ground;
a plurality of voltage regulators that include switches, inductors, and capacitors, wherein the voltage regulators regulate voltage by changing a duty ratio of the switches,
wherein the terminal connected to the high voltage of the charge distributor is connected to a high voltage terminal of a system, and the low voltage side of the voltage regulators are connected to a low voltage terminal of the system.
   64. A system comprising: a
substrate;
a core on a first die of the substrate; and
a voltage regulator module on a second side of the substrate, the second side being opposite to the first side,
wherein the voltage regulator module comprises:
   a magnetic core having twelve voids arranged in a four-by-three grid that form four lengths of magnetic core material between two ends,
   electrically conductive windings that wrap the four lengths of magnetic core material, the windings looping through at least one of the twelve voids, and
   a plurality of switches.
      65. The system of clause 64, wherein power is delivered from the voltage regulator module to the core.
      66. A coupled inductor comprising:
a magnetic core comprising a plurality of voids; a
plurality of electrically conducting windings;
   wherein each winding is at least partially disposed in two of the voids, each winding including a flat face adjacent a top face of the magnetic core, each winding further including two posts located on opposite sides of the winding, each post disposed orthogonal to a bottom face of the magnetic core, each post extending at least to the bottom face of the magnetic core, each post disposed in a different void than the other,
   wherein at least two of the windings are partially disposed in the same void, and
   wherein each void includes two windings at least partially disposed within it; and
a magnetic plate disposed adjacent to, and separated by a gap from, the top face of the magnetic core, wherein the magnetic plate comprises a material different from the magnetic core.
   67. The coupled inductor of clause 66, wherein the gap between the magnetic plate and the top face of the magnetic core is between 0.05 mm-5.00 mm.
   68. The power converter circuit of clause 31, wherein current charging and discharging the capacitor is a pulsed square wave current.
   69. The coupled inductor of clause 46, further comprising:
a second void and a third void in conjunction with the first void,
the first void, the second void, and the third void forming four lengths of magnetic core material between the two ends.

What is claimed is:

1. A power converter circuit comprising:
at least one charge distributor that include switches, capacitors, and inductors, wherein:
the at least one charge distributor has a fixed voltage conversion ratio; the switches in the at least one charge distributor operate at a common frequency; and
each of the at least one charge distributor has four terminals with one terminal connected to a high voltage, one terminal connected to ground, and two branch terminals having a voltage between the high voltage and ground;
a plurality of voltage regulators that include switches, inductors, and capacitors, wherein the voltage regulators regulates voltage by changing a duty ratio of the switches,
wherein the terminals connected to the high voltage of the at least one charge distributor are connected to a high voltage terminal of a system, and the low voltage side of the voltage regulators are connected to a low voltage terminal of the system.
